(19) United States
(12) Patent Application Publication
(10) Pub. No.: US 2003/0054103 A1
(43) Pub. Date: Mar. 20, 2003

(54) Curable coating composition, curable ink, printing method thereof and printed matter

(75) Inventors: Kouji Sato, Tokyo (JP); Masayoshi Utsugi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Toyo Ink Mfg. Co., Ltd., Tokyo (JP)

(21) Appl. No.: 10/151,108

(22) Filed: May 21, 2002

(30) Foreign Application Priority Data
May 21, 2001 (JP) 2001-150240

(51) Int. Cl. B05D 3/06

(52) U.S. Cl. 427/256; 427/551

(57) ABSTRACT

A curable coating composition comprising a polymer of an aromatic vinyl compound and an α,β-unsaturated carboxylic acid ester; a vegetable oil or a fatty acid ester thereof; and a (metha) acrylic monomer or (metha) acrylic oligomer, and a printing method thereof are disclosed. A printing ink utilizing the curable coating composition of the present invention can be printed with a printing machine used for oil-based inks. At the same time, if in combination with an activation energy beam curable overprint varnish, glossy printed matters having aesthetically high-grade feeling can be obtained.

### CROSS REFERENCE OF THE RELATED APPLICATIONS

The application is based upon and claims the benefit of priority from the prior Japanese Patent Application No. 2001-150240, which was filed on May 21, 2001, and the entire contents of which are incorporated herein by reference.

### BACKGROUND OF THE INVENTION

1. Field of the Invention

The present invention relates to curable coating compositions, curable inks therewith, printing methods therewith, and obtained printed mattel

2. Description of the Related Art

In the printing of various kinds of materials such as paper containers, books, posters, calendars, labels, wrapping papers, and cards, in order to give aesthetic high-grade feeling and various kinds of resistance properties (abrasion-resistance, water-resistance, oil resistance, solvent resistance) thereto, after an ink has been printed, it has been customary to coat an overcoat varnish thereon, in particular an activation energy beam curable overcoat varnish. For instance, a method in which after an oil-based ink (having oxidative polymerizable property) has been printed, the printed matter is left piled up for several days until the ink becomes dry, thereafter an activation energy beam curable overcoat varnish is coated (off-line system of oil-based ink/activation energy beam curable overcoat varnish), a method in which after an activation energy beam curable ink has been printed, immediate thereafter, an activation energy beam curable overcoat varnish is coated (in-line system of an activation energy beam curable ink/activation energy beam curable overcoat varnish) or the like has been adopted. However, there are problems in that in the former off-line system, working efficiency is low, and in the latter in-line system, the activation energy beam curable ink is high in cost. In addition, in the aforementioned oil-based ink, volatile hydrocarbon-based ink solvents that are mineral oil fractions have been used with frequency. However, in recent years, in consideration of environmental problems, there are high needs in VOC (Volatile Organic Compound)-free inks in which a volatile hydrocarbon-based ink solvent is completely eliminated from the oil-based ink. For instance, according to Fukuda and Ishii (Journal of Printing Science and Technology, 37 (5), p.51), when the VOC-free offset printing inks are made available, 40 thousand tons or more of the printing ink petroleum solvents may be cut.

In consideration of the inefficiency in the off-line system, a method has been tried in that adjacent to an oil-based ink multi-color printing machine, a coater and an activation energy beam irradiator are arranged, and immediately after the oil-based ink has been printed, an activation energy beam curable overcoat varnish is coated and cured. According to this method, however, there is a problem in that gloss decrease gradually, in particular, when rather than mono-color coating, multi-color recoating is performed and a higher thickness results, a decrease in the gloss continues for several days (gloss-back) and aesthetic high-grade feeling is deteriorated, resulting in losing its commercial value.

Furthermore, printing companies that have only the oil-based ink multi-color printing machine may try to print by use of the aforementioned activation energy beam curable ink/activation energy beam curable varnish in-line system. In this case, however, the activation energy beam curable ink may permeate into a printing machine rubber roll and a blanket and swell there. As a result, the ink mal-transfer may results, that is, when printing a next image different in pattern, the previous images in the swollen portions may be thinly printed ghost-likely on the next printed matter. As a result, commercial values of the printed matter may be deteriorated. In addition, there are further various kinds of problems in that a cleaning liquid for use in the oil-based ink system cannot be used as the cleaning liquid of printing machines or the like. The rubber roll and the blanket for use in printing machine have to be changed, accordingly, to ones that have durability against the activation energy beam curable ink. Or, a multi-color printing machine dedicated to the activation energy beam curable ink has to be newly introduced.

As mentioned above, an ink/varnish printing system that allows to suppress the gloss back phenomena after the varnish coating and to print by use of oil-based ink multi-color printing machine without causing any problems has been expected to develop.

### SUMMARY OF THE INVENTION

An object of the present invention is to provide curable ink that does not cause the aforementioned gloss back, curable coating compositions therefor, printing method thereof and printed matter thereby, while the curable ink maintains excellent properties, which ordinary oil-based printing ink have, such as swell-resistance, good cleanability, emulsion printing properties, good misting properties and the like, and low-cost as well. Even when an in-line printing in which a multi-color printing process is applied followed by piling up, or immediate thereafter in a wet state followed by coating an activation energy beam curable overcoat varnish, and further followed by irradiating an activation energy beam, is implemented, the curable ink does not cause the aforementioned gloss back.

The present inventors have studied hard the problems and found a cue to solve these problems in a way by which an oil-based ink and activation energy beam curable ink are mixed to form a curable ink. That is, we have found that (1) simple mixing of these causes a decline in ink fluidity and ink mal-transfer at printing, that is, the problems still remain, (2) these inconveniences are caused due to poor solubility between the oil-based ink and the activation energy beam curable ink in a resultant ink, and (3) when a particular group of compounds (which will be detailed later) that shows compatibility with the aforementioned oil-based ink and activation energy beam curable ink and at the same time does not substantially adversely affect on ink properties is selected and added to the ink as a compatibility agent, these problems can be overcome. Thus, we have come to the completion of the present invention.

Another object of the present invention is to provide curable ink in which any volatile organic compound (VOC) such as petroleum-based solvents and the like is not used, and printed matter obtained therewith. That is, it is to provide a VOC free ink in which thermal weight loss (excluding water) based on the VOC measurement method Method 24 (thermal residual measurement after heating at a temperature of 110° C. for 1 hr), which is proposed by the United State Government Environmental Protection Agency, is suppressed to 1% or less, and printed matter obtained therewith.

As one of environmental measures, there is a demand for soybean oil ink in which a part of petroleum components and drying oil that are contained in offset ink is replaced by soybean oil or modified one thereof and which satisfies ASA (American Soybean Association) standards for recognition. According to the present invention, it is possible that the aforementioned standards are satisfied. It should be noted however that the ink according to the present invention may also be curable ink that does contain volatile organic compounds (VOCs) such as conventional petroleum-based solvents.

The present invention is a curable coating composition comprising (a) a polymer of an aromatic vinyl compound and an α,β-unsaturated carboxylic acid ester, (b) a vegetable oil or a fatty acid ester thereof, and (c) a (metha) acrylic monomer or (metha) acrylic oligomer.

The α,β-unsaturated carboxylic acid ester is preferably a (metha) acrylic acid ester of a C1 to C20 monohydric fatty alcohol or a (metha) acrylic acid ester of a C5 to C60 cyclic alcohol. In the latter case, said C5 to C60 cyclic alcohol may be a terpene alcohol.

The curable coating composition of the present invention may further comprise a resin having a softening temperature in the range of 50 to 180° C.

The curable coating composition of the present invention may further comprise a metallic dryer and/or a radical polymerization initiator.

The curable coating composition of the present invention may further comprise a coloring agent.

The present invention is also a printing ink comprising the curable coating composition of the present invention and a coloring agent.

The present invention is also a method for printing a curable ink on a substrate, the method comprising the steps of (a) applying the printing ink aforementioned on a substrate to form an ink surface of the printing ink, (b) further applying, in an uncured state of the printing ink, an activation energy beam curable overcoat varnish on the ink surface, and (c) irradiating an activation energy beam onto the printing ink and activation energy beam curable overcoat varnish applied.

Still further, the present invention is a printed matter produced according to the method aforementioned.

In the curable coating composition of the present invention, the aromatic vinyl compound is preferably in an amount of 1 to 99% by weight based on a total amount of the aromatic vinyl compound and the α,β-unsaturated carboxylic acid ester. In the curable coating composition of the present invention, the polymer is preferably in an amount of 1 to 50% by weight based on an amount of the curable coating composition.

In particular, the present invention may be curable coating compositions, more specifically, to curable inks, which may comprise vegetable oil or fatty acid ester thereof as an oil-based material; oil-soluble resin whose softening temperature is in the range from 50 to 180° C.; (metha) acrylic monomer or (metha) acrylic oligomer; and a copolymer between an aromatic vinyl compound and an ester of α,β-unsaturated carboxylic acid, that works as a compatibility agent. They have oil solubility, oxidative polymerizability, and acrylic polymerizability, all together.

According to the present invention, while maintaining excellent properties of ordinary oil-based printing ink such as swell-resistance, good cleanability, emulsion printing properties, good misting properties and the like as well as low-cost, even when multi-color printing is followed by piling up, or immediate thereafter in a wet state, followed by coating an activation energy beam curable overcoat varnish, and further followed by irradiating an activation energy beam, thereby performing an in-line printing method, glossy high-grade printed matters in which the gloss back that is pointed out in the above is suppressed can be provided.

### DETAILED DESCRIPTION OF THE INVENTION

In the following, the present invention will be further described in detail.

Examples of aromatic vinyl compounds that may be used in the present invention include, for instance, styrene, divinylbenzene, vinyl toluene, 1-vinylnaphthalene, 2-vinylnaphthalene, 9-vinylanthracene, 2-vinylphenanthrene, 3-vinylphenanthrene, acenaphthyrene, phenylvinyl ether, o-cresyl vinyl ether, p-cresyl vinyl ether, α-naphtylvinyl ether, and β-naphtylvinyl ether.

Examples of α,βunsaturated carboxylic acids that may be used in the present invention include, for example, fumaric acid, maleic acid or anhydride thereof, itaconic acid, citraconic acid, crotonic acid, cinnamic acid, and (metha) acrylic acid.

Examples of alcohols constituting the α,β-unsaturated carboxylic acid include monohydric aliphatic alcohols of C1 to C20 such as methanol, ethanol, propanol, butanol, hexanol, octanol, nonanol, decanol, dodecanol, tridecanol, hexadecanol, octadecanol, icosanol, and allyl alcohol.

In addition, hydroxy group containing compounds after the esterification reaction of fatty acids of C1 to C20 and two or more-hydric polyols, for instance, ethyleneglycol monobutyl ester, propyleneglycol monohexyl ester, α,β-unsaturated carboxylic acid ester of dioctyl acid of glycerin or trimethylolpropane and the like can be cited. Furthermore, as esters of α,β-unsaturated carboxylic acid, glycidil (metha) acrylate, dicyclo pentenyl (metha) acrylate, 2-methoxyethyl (metha) acrylate, 2-hydroxy-3phenoxy propyl (metha) acrylate, 2-hydroxy propyl (metha) acrylate, 4-hydroxy buthyl (metha) acrylate and the like of commercially available fatty acids, other alcohols or phenols can be cited.

Furthermore, (metha) acrylic acid esters made of cyclic alcohols of C5 to C60, for instance, benzyl alcohol, ethylene oxide or propylene oxide of carbolic acid, ethylene oxide or propylene oxide of cresol, ethylene oxide or propylene oxide of butyl phenol, ethylene oxide or propylene oxide of octylphenol, ethylene oxide or propylene oxide of nonylphenol, and ethylene oxide or propylene oxide of dodecyl phenol, alicyclic alcohols, for instance, rosin alcohol (Abitol produced by Hercules Inc.), tricyclodecane (mono or di) methylol, C5 petroleum resin allyl alcohol copolymer, and the like can be cited. Still furthermore, (metha) acrylic esters such as ethylene glycol monorosin ester, trimethylol propane or glycerin dirosin ester, pentaerythritol trirosin ester and the like can be cited. Furthermore, α,β-unsaturated carboxylic acid esters of terpene alcohols, such as borneol (bornyl alcohol), isoborneol (isobornyl alcohol), citronellol, pinocampheol, geraniol, fenchyl alcohol, nerol, linalool, menthol, terpineol, carveol, thujyl alcohol, farnesol, pachouli alcohol, nerolidol, carotol, cadinollanceol, eudesmol, cedrol, guaiol, kessoglycol, phytol, sclareol, manool, hinokiol, ferruginol, totalol, and the like, can be cited.

The esterification reaction between at least one kind of alcohol compound selected from the aforementioned group and α,β-unsaturated carboxylic acid may be performed according to an ordinary method, and generally performed in the following ways. That is, the aforementioned alcohol compound, α,β-unsaturated carboxylic acid and a polymerization inhibitor are introduced into a four-necked flask fitted with a stirrer, a thermometer and a condenser with a separator. Thereafter, while purging with air, or a mixture of air and nitrogen, or nitrogen, in the presence of a solvent, such as toluene, MIBK, cyclohexane or the like, the reaction is allowed to proceed at a temperature in the range of 80 to 120° C. for 5 to 20 hrs until an acid value becomes 20 or less, preferably 15 or less, further preferably 10 or less. Then, the inside of the flask is depressurized to remove the solvent.

As esterification catalysts, sulfonic acids, such as p-toluene sulfonic acid, dodecylbenzen sulfonic acid, methane-sulfonic acid, ethane-sulfonic acid and the like, mineral acids, such as sulfuric acid, hydrochloric acid and the like, trifluoromethyl sulfonic acid, trifluoromethyl acetic acid, Lewis acid and the like may be used. Other than these, metal complexes, such as tetrabutyl zirconate, tetraisopropyl titanate and the like, alkali and alkali earth oxides, such as magnesium oxide, calcium oxide, zinc oxide and the like, and metal salt catalysts may also be used. An amount by which a catalyst is used is generally in the range of from 0.1 to 5% by weight. Furthermore, under such conditions reactants may be tinted in some cases. For avoiding this, reducing agents such as hypophosphorous acid, triphenyl phosphite, triphenyl phosphate and the like may be used together.

As polymerization inhibitors, for instance, alkyl phenol, hydroquinone, catechol, resorcin, p-methoxy phenol, t-butyl catechol, t-hydroquinone, pyrogallol, 1,1-picryl hydrazyl, phenothiazine, p-benzoquinone, nitroso benzene, 2,5-di-tert-butyl-p-benzoquinone, dithiobenzoyl disulfide, picric acid, cupferron, A1-N-nitrosophenyl hydroxyl amine, tri-p-nitrophenyl methyl, N-(3-oxyanilino-1,3-dimethylbutylidene) aniline oxide, di-butyl cresol, cyclohexanone oxime cresol, guajacol, o-isopropyl phenol, butyraldoxime, methylethyl ketoxime, or cyclohexanone oxime may be used.

An aromatic vinyl compound and α,β-unsaturated carboxylic acid are allowed to polymerize and obtain an ester under the conditions of 60 to 120° C., more preferably 80 to 100° C., in the presence of thermal polymerization catalysts, for instance, peroxides such as benzoylperoxide, cumene hydroperoxide, t-butyl hydroperoxide, isopropyl peroxycarbonate, di-t-butylperoxide, lauroyl peroxide, t-butylperuoxybenzoate and the like; azobis compounds such as azobisisobutyrolnitrile, azobis 2,4 dimethylvaleronitrile and the like; tetramethyl thiuram disulfide, alkali metal and oxygen or oxygen compounds, triethyl boron or tributyl boron and oxygen, diethyl zinc and oxygen; or metal carbonyls such as Cr(CO)₆, Mo(CO)₆, W(CO)₆, Mn(CO)₆, Ni(CO)₆ and the like.

For reaction solvents, n-hexane, cyclohexane, ethyl cyclohexane, benzene, toluene, xylene, ethyl benzene, ethyl acetate, butyl acetate, MEK, MIBK, diisobutyl ketone, cyclohexanone, ethanol, isopropanol, buthanol and the like can be cited. The solvent is allowed to remain as it is, or removed by decompression.

A reaction ratio of an aromatic vinyl compound and α,β-unsaturated carboxylic acid is in the range of 1 to 99% by weight, preferably 10 to 90% by weight, in terms of weight of an aromatic vinyl compound to a total weight of the aromatic vinyl compound and α,β-unsaturated carboxylic acid, and in the range of 1 to 99% by weight, preferably 10 to 90% by weight in terms of weight of α,β-unsaturated carboxylic acid to a total weight of the aromatic vinyl compound and α,β-unsaturated carboxylic acid.

In general, when the aromatic vinyl compound is used more than the above amount, the polymer becomes difficult to dissolve in vegetable oil or fatty acid ester thereof or resin having a softening temperature in the range of 50 to 180° C. By contrast, when the aromatic vinyl compound is used less than the above amount, the polymer becomes difficult to dissolve in (metha) acrylic monomer or (metha) acrylic oligomer having an ethylenically unsaturated double bond. In other words, when the α,β-unsaturated carboxylic acid is used more than the above amount, the polymer becomes difficult to dissolve in (metha) acrylic monomer or (metha) acrylic oligomer having an ethylenically unsaturated double bond. By contrast when the α,β-unsaturated carboxylic acid is used less than the above amount, the polymer becomes difficult to dissolve in the vegetable oil or fatty acid ester thereof, or resin having a softening temperature in the range of 50 to 180° C.

In general, a vegetable oil or fatty acid ester thereof or a resin having a softening temperature in the range of 50 to 180° C., which is an oil-based material, and a (metha) acrylic monomer or (metha) acrylic oligomer having activation energy beam curability are difficult to dissolve in each othel The polymer according to the present invention dissolve in the vegetable oil or fatty acid ester thereof and the oil soluble resin having a softening temperature in the range of 50 to 180° C., which are an oil-based components of material, and also in the (metha) acrylic monomer or (metha) acrylic oligomer having activation energy beam curability, thus plays a role of catalyst for both.

Examples of the resin having a softening temperature in the range of 50 to 180° C. are, for example, rosin modified phenolic resins, petroleum resins, α,β-ethylenically unsaturated carboxylic acid-modified petroleum resins, alkyd resins, rosin ester resins such as rosin-modified alkyd resins and α,β-ethylenically unsaturated carboxylic acid-modified rosin ester resins, rosins and petroleum-modified ester resins, melamine resins, terpene resins, chroman/indene resins, ketone resins, phenol-modified petroleum resins, and diallylphthalate resins.

Rosin modified phenolic resins may be obtained according to the ordinary method as shown in the following. That is, first, phenols such as carbolic acid, hydroquinone, catechol, resorcin, bisphenol A, bisphenol F, (tertiary) butylphenol, (tertiary) octylphenol, nonylphenol, dodecylphenol, hexylphenol or combinations thereof and formaldehyde are allowed to perform condensation, thereby resol or novolak phenolic resin is obtained. Then, the obtained resol phenolic resin or novolak phenolic resin and rosins such as gum rosin, wood rosin, tall oil rosin, hydrated rosin, disproportionated rosin and polymerized rosin are allowed to perform chroman reaction, followed by esterification reaction in the presence of polyols such as glycerol or pentaerythritol and the like or an acid catalyst such as p-toluene sulfonic acid, meta-sulfonic acid, sulfuric acid and the like. The obtained resin has a weight average molecular weight of 10,000 to 150,000.

Moreover, petroleum resins formed of 5-membered cyclic compounds (C5 distillate) such as cyclopentadiene and the like or C9 distillate, or alpha,beta-unsaturated carboxylic acid ester-modified petroleum resins can be cited. As the alpha,beta-unsaturated carboxylic acid ester resins, acid-modified petroleum resins that are obtained by denaturing petroleum resin that contains C5 or C9 distillate with alpha,beta-ethylenically unsaturated carboxylic acid or anhydride thereof; ester modified petroleum resins that are obtained by esterifying alkylene dihydric alcohol having 6 to 20 carbon atoms and/or trimethylol (the number of carbon atoms is in the range of 4 to 18) alkane or alkene; furthermore, ester modified petroleum resins that are obtained by esterifying by use of alkyl (having 4 to 30 carbon atoms) or alkenyl succinic acid or anhydride thereof; still furthermore, ester modified petroleum resins that are obtained by esterifying by use of the aforementioned aliphatic or cyclic monohydric alcohols set forth in the present specification, saturated or unsaturated fatty acid, and at least one kind selected from a group including the aforementioned rosins or alpha,beta-ethylenically unsaturated carboxylic acid thereof or anhydride thereof modified resin, can be cited.

As the petroleum resins formed of 5-membered cyclic compounds (C5 distillate) such as cyclopentadiene and the like or C9 distillate, MARUKAREZ T-100, M890, M845, M510, and M905 produced by Maruzen Petrochemical Company Limited and COPOREX #2100, Hiresin #120, #130 and the like produced by Toho Chemical Industry Co., Ltd. can be cited.

Other compounds similar to the aforementioned α,β-ethylenically unsaturated carboxylic acid and acid anhydride thereof can be cited. A denaturing amount thereof may be varied in the range of 1 to 100% to petroleum resin monomer consisting of C5 or C9 distillate that is used in the present invention. However, the denaturing amount is usually varied in the range of 0.01 to 0.5 moles to 100 g of the petroleum resin. A denaturing temperature in the range of 150 to 250° C. is preferably employed.

As linear or branched alkylene dihydric alcohols having 6 to 20 carbon atoms, hexanediol, octanediol, nonanediol and the like can be cited. Next, as the branched alkylene dihydric alcohols, 2-methylpentanediol, 2-methyl-2 propyl-propanediol, 2,4 dimethy-pentanediol, 2,2-diethyl-propanediol, 2,2,4-trimethyl-pentanediol, dimethylol octane (produced by Mitubishi Chemical Co.), 2,5 dimethyl-hexanediol, 2-methyl-octanediol, 2-butyl-2-ethyl-propanediol, 2,4-diethyl-pentanediol and the like can be cited. As needs arise, glycols such as ethylene glycol and propylene glycol can be used together.

As specific examples of the aforementioned succinic acid having alkyl group or alkenyl group having 4 to 30 carbon atoms or anhydrides thereof, linear or branched alkyl group-substituted (anhydrous) succinic acid, such as, octenyl (anhydrous) succinic acid, dodecenyl (anhydrous) succinic acid, penta-decenyl (anhydrous) succinic acid, and the like can be cited.

In the aforementioned esterification reaction, as needs arise, the aforementioned esterification catalysts can be used. A weight average molecular weight of the ester-modified petroleum resin that is preferably used in the present invention is in the range of 10,000 to 300,000, preferably in the range of 20,000 to 150,000.

Still furthermore, when resin that is obtained by esterifying, according to the conventional method, the aforementioned α,β-unsaturated carboxylic acid ester-modified petroleum resin and polyols, such as ethylene glycol, glycerin, trimethylol ethane, trimethylol propane, pentaerythritol and the like, or hydroxyl group containing resin that is obtained by esterifying with excess polyol is allowed to react, according to the conventional method, with polybasic acid, such as phthalic anhydride, isophthalic acid, terephthalic acid, (anhydrous) trimellitic acid, succinic anhydride and (anhydrous) maleic acid, resins having a weight average molecular weight of 5000 to 150,000 can be obtained.

As the aforementioned rosin ester resins, there are rosin alkyd resin and α,β-ethylenically unsaturated carboxylic acid-modified rosin ester resin and the like. As the rosin alkyd resin, ones that are obtained by allowing reacting, according to the conventional method, Diels-Alder reaction product with the aforementioned rosins or α,β-ethylenically unsaturated carboxylic acid or anhydride thereof with the aforementioned polyols or polybasic acids can be cited. A weight average molecular weight is in the range of 5000 to 150,000.

The α,β-ethylenically unsaturated carboxylic acid-modified rosin ester resin can be obtained by allowing to react the Diels-Alder reaction product between the aforementioned rosins and α,β-ethylenically unsaturated carboxylic acid or anhydride thereof with trimethylol (the number of carbon atoms is 4 to 18) alkane or alkene and/or polyols other than those. The composition ratio thereof is in the range of 80/20 to 97/3 in terms of weight ratio of rosins to α,β-ethylenically unsaturated carboxylic acid or anhydride thereof, and in the range of 1/0.5 to 1/1.2 in terms of mole ratio of a total mole number of carboxylic acid in rosins and α,β-ethylenically unsaturated carboxylic acid or anhydride thereof to a total mole number of hydroxyl groups in trimethylol alkane or alkene having 4 to 18 carbon atoms and polyols other than those. In the above reaction, it can be illustrated to use together the rosins and the petroleum resin of C5 and C9 distillate in the range of from 10 to 90 to from 90 to 10 in terms of weight ratio of the rosins to the petroleum resin of C5 and C9 distillate.

The reaction between the rosins and the α,β-unsaturated carboxylic acid or anhydride thereof proceeds according to Diels-Alder reaction, and the Diels-Adler reaction is allowed to proceed according to the known method. For instance, a reaction temperature is in the range of 150 to 260° C. and a reaction time period is in the range of 1 to 4 hrs. The trimethylol (the number of carbon atoms is 4 to 18) alkane or alkene of the present invention is as mentioned above.

A reaction ratio between the reaction product of the rosins and α,β-ethylenically unsaturated carboxylic acid or anhydride thereof, and trimethylol (the number of carbon atoms is 4 to 18) alkane or alkene is in the range of 1/0.8 to 1/1 in terms of a total mole number of carboxylic acid of the reaction product between the above rosins and the α,β-ethylenically unsaturated carboxylic acid or anhydride thereof to a total mole number of hydroxyl groups of trimethylol alkane or alkene. The esterification reaction is allowed to proceed under a temperature in the range of 180 to 270° C. until the acid value becomes substantially 20 to 30. The esterification reaction is allowed to proceed without catalyst or with the aforementioned catalyst. The reaction is allowed to proceed at a temperature of 200° C. or more in the presence of catalyst of 0.01 to 1% by weight to the total resin. As the polyols other than trimethylol (the number of carbon atoms is 4 to 18) alkane or alkene, aliphatic polyhydric alcohols, such as ethylene glycol, propylene glycol, neopentil glycol, glycerin, trimethylol ethane, trimethylol propane, pentaerythritol and sorbitol, and cyclic polyhydric alcohols, such as tris (2-hydroxyethyl) isocyanurate, inositol and the like, can be cited. From a viewpoint of proper molecular weight of the resin, melting point, and cost, as the other polyols being used together, glycerin, trimethylol propane and pentaerythritol are preferable.

When the resin is used for printing ink in accordance with the present invention, the acid value is preferable to be 30 or less; the weight average molecular weight preferably in the range of 10,000 to 200,000 (as measured by gel permeation chromatography); and the melting point preferably in the range of 50 to 180° C.

Still furthermore, as the α,β-ethylenically unsaturated carboxylic acid-modified rosin ester resin, resin that is obtained by reacting the Diels-Alder reaction product of the aforementioned rosins and the α,β-ethylenically unsaturated carboxylic acid or anhydride thereof with the above mentioned monohydric alcohol and polyols disclosed in the present specification can be cited.

The reaction between the rosins and the α,β-ethylenically unsaturated carboxylic acid or anhydride thereof is allowed to proceed according to the aforementioned synthesis method. Furthermore, the aforementioned monohydric alcohols of the present invention are used in the reaction. As the polyols, the aforementioned polyols are cited. A reaction ratio between the reaction product of the rosins and α,β-ethylenically unsaturated carboxylic acid or anhydride thereof, and the monohydric alcohol and polyols is set in the range of 1/0.8 to 1/1.2 in terms of a total mole number of carboxylic acid in the above rosins and the α,β-ethylenically unsaturated carboxylic acid or anhydride thereof to a total mole number of hydroxyl groups of the aforementioned C5 to C30 monohydric acid and polyols. The esterification reaction is allowed to proceed under a temperature in the range of 180 to 270° C. until the acid value becomes substantially 20 to 30. In this esterification reaction, the aforementioned catalyst may be used. When the resin is used for printing ink based on the present invention, the acid value is preferable to be 30 or less; the weight average molecular weight preferably in the range of 10,000 to 200,000 (as measured by gel permeation chromatography); and the melting point preferably in the range of 50 to 180° C.

A resin is obtained by reacting the Diels-Alder reaction product between the rosins and α,β-ethylenically unsaturated carboxylic acid or anhydride thereof with polyols and fatty acid, still furthermore the rosins and α,β-ethylenically unsaturated carboxylic acid or anhydride thereof being synthesized according to the aforementioned method.

Furthermore, in the resin, a ratio of a total number of moles of carboxylic acid in the rosins and α,β-ethylenically unsaturated carboxylic acid or anhydride thereof to a total number of moles of hydroxyl groups in hydroxyl group containing compound and polyols is in the range of 1/0.5 to 1/1.2.

As the polyols of the present invention, the aforementioned polyols can be cited. As the fatty acid, ones that are mentioned above in the specification can be used. Furthermore, dimmer acids such as tung oil dimmer fatty acid, linseed oil dimmer fatty acid and the like can be cited.

In the present reaction method, the reaction product of the rosins and the α,β-ethylenically unsaturated carboxylic acid or anhydride thereof is allowed to react with polyols and fatty acid. A reaction ratio is set in the range of 1/0.5 to 1/1.2, preferably 1/0.8 to 1/1.2 in terms of a total number of moles of carboxylic acid in the above rosins, the α,β-ethylenically unsaturated carboxylic acid or anhydride thereof and fatty acid of the present invention to a total number of moles of hydroxyl groups of the aforementioned polyols. The esterification reaction is allowed to proceed at a temperature in the range of 180 to 270° C. until the acid value becomes substantially 20 to 30. This esterification reaction is performed according to the aforementioned method.

When the resin is applied for the printing ink which is in accordance with the present invention, the acid value is preferable to be 30 or less; a weight average molecular weight in the range of 10,000 to 200,000 (as measured by gel permeation chromatography), 130° C. or less; and the melting point, 100° C. or more, preferably 120° C. or more.

In the following, vegetable oils or fatty acid esters thereof that may be used in the present invention will be described. The vegetable oil is triglyceride of glycerin and fatty acid in which at least one fatty acid has at least one carbon-carbon unsaturated bond. As examples of representative compounds of such vegetable oils, hemp seed oil, linseed oil, nettle oil, oiticica oil, olive oil, cacao oil, kapok oil, torreya oil, mustard oil, apricot kernel oil, tung oil, candlenut oil, walnut oil, poppy seed oil, sesame oil, safflower oil, radish oil, soybean oil, hydrocarpus seed oil, camellia oil, corn oil, rapeseed oil, niger seed oil, rice bran oil, palm oil, castor oil, sunflower oil, grape seed oil, almond oil, pine seed oil, cotton seed oil, coconut oil, peanut oil, and dehydrated castor oil can be cited. When further preferable vegetable oils are listed l)up, the vegetable oils that have an iodine value of at least 100 or more (the iodine values quoted from YUSHIKAGAKU SEIHIN BINRAN published by NIKKANKOGYOU SHINBUNSHA are shown in brackets), such as hemp seed oil (149 or more), linseed oil (170 or more), nettle oil (192 or more), oiticica oil (140 or more), kapok oil (85 to 102), torreya oil (130 or more), mustard oil (101 or more), apricot kernel oil (97 to 109), tung oil (145 or more), candlenut oil (136 or more), walnut oil (143 or more), poppy seed oil (131 or more), sesame oil (104 or more), safflower oil (130 or more), radish oil (98 to 112), soybean oil (117 or more), hydrocarpus seed oil (101), corn oil (109 or more), rapeseed oil (97 to 107), niger seed oil (126 or more), rice bran oil (92 to 115), sunflower oil (125 or more), grape seed oil (124 or more), apricot kernel oil (93 to 105), pine seed oil (146 or more), cotton seed oil (99 to 113), peanut oil (84 to 102), and dehydrated castor oil (147 or more) can be preferably used. The ones that have the iodine value of 120 or more may be preferably used in some cases. When the iodine value is made 120 or more, drying properties in oxidative polymerization of the curable compositions may be enhanced.

Recently, as environmentally compatible ones, soybean oil or fatty acid ester thereof (soybean oil fatty acid alkyl ester and the like, such as soybean oil fatty acid ethyl ester, soybean oil fatty acid butyl ester and the like) can be cited.

Furthermore, epoxidized soybean oil, epoxidized soybean oil acrylic ester (CN111 produced by Sartomer Company, Ebecryl 860 produced by UCB Chemical Corporation), epoxidized linseed oil, epoxidized linseed oil acrylic ester, and furthermore other epoxidized fatty acids and epoxidized fatty acid acrylic esters can be cited.

Other than the above, in the present invention, vegetable oils that are used as food oil such as tempura oil, and thereafter recovered and reproduced can be used. As the reproduced vegetable oil, one that is reproduced so that water content may be 0.3% or less by weight, iodine value may be 100 or more, and acid value may be 3 or less can be preferably used. When the water content is reduced to 0.3% or less by weight, impurities such as salt component and the like that are contained in water and adversely affects on emulsion behavior of ink can be eliminated. When the used vegetable oil is reproduced with the iodine value of 100 or more, one that is excellent in good drying property, that is, excellent oxidative polymerizability can be obtained. Furthermore, when the vegetable oil whose acid value is 3 or less is selected and reproduced, since the acid value of the reproduced vegetable oil can be made lower, excess emulsification of ink may be suppressed. When the recovered vegetable oil is reproduced, precipitate can be removed by means of filter and still standing, and bleaching due to active clay may be applied.

Next, as the fatty acid esters in the present invention, fatty acid monoesters that are obtained by performing an esterification process between saturated or unsaturated fatty acid that is obtained through hydrolysis of vegetable oil and saturated or unsaturated alcohol can be cited. Among these, the fatty acid monoesters that are liquid at normal temperature (20 to 25° C.) and have boiling point of 200° C. or more at normal pressure (101.3 kPa) are preferable. Examples of such fatty acid monoesters are, for example, as the saturated fatty acid monoesters, hexyl butylate, heptyl butylate, octyl butylate, butyl capronate, acyl capronate, hexyl capronate, heptyl capronate, octyl capronate, nonil capronate, propyl enanthate, butyl enanthate, amyl enanthate, hexyl enanthate, heptyl enanthate, octyl enanthate, ethyl caprilate, vinyl caprilate, propyl caprilate, isopropyl caprilate, butyl caprilate, amyl caprilate, hexyl caprilate, heptyl caprilate, octyl caprilate, methyl peralgonate, ethyl peralgonate, vinyl peralgonate, propyl peralgonate, butyl peralgonate, amyl peralgonate, acid heptyl peralgonate, methyl caproate, ethyl caproate, vinyl caproate, propyl caproate, isopropyl caproate, butyl caproate, hexyl caproate, heptyl caproate, methyl laurate, ethyl laurate, vinyl laurate, propyl laurate, isopropyl laurate, butyl laurate, isoamyl laurate, hexyl laurate, and 2-ethyl-hexyl laurate.

Examples of saturated fatty acid esters that can be used in the present invention are, for example, ethyl oleate, propyl oleate, butyl oleate, alyll oleate, isoamyl oleate, heptyl oleate, 2-ethylhexyl oleate, methyl elaidate, ethyl elaidate, propyl elaidate, alyll elaidate, butyl elaidate, isobutyl elaidate, ter-butyl elaidate, isoamyl elaidate, 2-ethylhexyl elaidate, methyl linoleate, ethyl linoleate, allyl linoleate, propyl linoleate, isopropyl linoleate, butyl linoleate, isobutyl linoleate, ter-butyl linoleate, pentyl linoleate, hexyl linoleate, heptyl linoleate, 2-ethylhexyl linoleate, methyl linolenate, ethyl linolenate, allyl linolenate, propyl linolenate, isopropyl linolenate, butyl linolenate, isobutyl linolenate, ter-butyl linolenate, pentyl linolenate, hexyl linolenate, heptyl linolenate, 2-ethylhexyl linolenate, methyl arachidonate, ethyl arachidonate, allyl arachidonate, propyl arachidonate, isopropyl arachidonate, butyl arachidonate, isobutyl arachidonate, ter-butyl arachidonate, pentyl arachidonate, hexyl arachidonate, heptyl arachidonate, 2-ethylhexyl arachidonate, methyl eicosenate, ethyl eicosenate, allyl eicosenate, propyl eicosenate, isopropyl eicosenate, butyl eicosenate, isobutyl eicosenate, ter-butyl eicosenate, pentyl eicosenate, hexyl eicosenate, heptyl eicosenate, 2-ethylhexyl eicosenate, methyl eicosapentaenate, ethyl eicosapentaenate, allyl eicosapentaenate, propyl eicosapentaenate, isopropyl eicosapentaenate, butyl eicosapentaenate, isobutyl eicosapentaenate, ter-butyl eicosapentaenate, pentyl eicosapentaenate, hexyl eicosapentaenate, heptyl eicosapentaenate, 2-ethylhexyl eicosapentaenate, methyl erucate, ethyl erucate, allyl erucate, propyl erucate, isopropyl erucate, butyl erucate, isobutyl erucate, ter-butyl erucate, pentyl erucate, hexyl erucate, heptyl erucate, 2-ethylhexyl erucate, methyl docosahexanoate, ethyl docosahexanoate, allyl docosahexanoate, propyl docosahexanoate, isopropyl docosahexanoate, butyl docosahexanoate, isobutyl docosahexanoate, ter-butyl docosahexanoate, pentyl docosahexanoate, hexyl docosahexanoate, heptyl docosahexanoate, 2-ethylhexyl docosahexanoate, methyl ricinoleate, ethyl ricinoleate, allyl ricinoleate, propyl ricinoleate, isopropyl ricinoleate, butyl ricinoleate, isobutyl ricinoleate, ter-butyl ricinoleate, pentyl ricinoleate, hexyl ricinoleate, heptyl ricinoleate, and 2-ethylhexyl ricinoleate.

As the saturated or unsaturated fatty acids that constitute fatty acid esters of the present invention, practically, coconut oil fatty acid, palm oil fatty acid, rapeseed oil fatty acid, soybean oil fatty acid, hydrated soybean oil fatty acid, linseed oil fatty acid, tung oil fatty acid, tall oil fatty acid, dehydrated castor oil fatty acid, or fatty acids fractionated by means of fractional distillation thereof may be used. The fatty acids are obtained as mixtures of the aforementioned saturated or unsaturated fatty acids.

In the following, (metha) acrylic monomers or acrylic oligomers that have ethylenically unsaturated double bond will be described.

Examples of the (metha) acrylic monomers that have an ethylenically unsaturated double bond and can be used in the present invention are, as monomers having one functional group, alkyl (the number of carbon atoms is from 2 to 18) (metha) acrylate, for instance, ethyl (metha) acrylate, butyl (metha) acrylate, hexyl (metha) acrylate, octyl (metha) acrylate, dodecyl (metha) acrylate, stearyl (metha) acrylate, benzyl (metha) acrylate, isobornyl (metha) acrylate, cyclohexyl (metha) acrylate, and tricyclodecamonomethylol (metha) acrylate. Examples of monomers having two functional groups are, for example, ethylene glycol di (metha) acrylate, polyethylene glycol di (metha) acrylate, propylene glycol di (metha) acrylate, dipropylene glycol di (metha) acrylate, tripropylene glycol di (metha) acrylate, polypropylene glycol di (metha) acrylate, butylene glycol di (metha) acrylate, pentyl glycol di (metha) acrylate, neopentyl glycol di (metha) acrylate, hydroxypivalyl hydroxypivalate di (metha) acrylate (popular name is Manda), hydroxypivalyl hydroxypivalate di-caprolactonate (metha) acrylate, 1,6 hexanediol di (metha) acrylate, 1,8 octanediol di (metha) acrylate, 1,9 nonanediol di (metha) acrylate, 1,2 hexadecandiol di (metha) acrylate, 2-methyl-2,4-pentanediol di (metha) acrylate, 3-methyl-1,5-pentanediol di (metha) acrylate, 2-methyl-2-propyl-1,3-propanediol di (metha) acrylate, 2,4-dimethyl-2,4-pentanediol di (metha) acrylate, 2,2-diethyl-1,3-propanediol di (metha) acrylate, 2,2,4-trimethyl-1,3-pentanediol di (metha) acrylate, dimethylol octanediol di (metha) acrylate, 2-ethyl-1,3-hexane diol di (metha) acrylate, 2,5-dimethyl-2,5-hexanediol di (metha) acrylate, 2-methyl-1,8-octanediol di (metha) acrylate, 2-butyl-2-ethyl-1,3-propanediol di (metha) acrylate, 2,4-diethyl-1,5-pentanediol di (metha) acrylate, 2-methyl-2,4-pentanediol di (metha) acrylate, 3-methyl-1,5-pentanediol di (metha) acrylate, 2-methyl-2-propyl-1,3-propanediol di (metha) acrylate, 2,4-dimethyl-2,4-pentanediol di (metha) acrylate, 2,2-diethyl-1,3-propanediol di (metha) acrylate, 2,2,4-trimethyl-1,3-pentanediol di (metha) acrylate, dimethylol octanediol di (metha) acrylate (Mitubishi Chemical Co.,), 2-ethyl-1,3-hexanediol di (metha) acrylate, 2,5-dimethyl-2,5-hexanediol di (metha) acrylate, 2-butyl-2-ethyl-1,3-propanediol di (metha) acrylate, 2,4-diethyl-1,5-pentanediol di (metha) acrylate, tricyclodecane dimethylol di (metha) acrylate, tricyclodecane dimethylol di-caprolactonate di (metha) acrylate, bisphenol A tetraethyleneoxide adduct di (metha) acrylate, bisphenol F tetraethyleneoxide adduct di (metha) acrylate, bisphenol S tetraethyleneoxide adduct di (metha) acrylate, hydrated bisphenol A tetraethyleneoxide adduct di (metha) acrylate, hydrated bisphenol F tetraethyleneoxide adduct di (metha) acrylate, hydrated bisphenol A di (metha) acrylate, and hydrated bisphenol F di (metha) acrylate. Examples of monomers having three functional groups are, for example, glycerin tri (metha) acrylate, trimethylol propane tri (metha) acrylate, trimethylol propane tri-caprolactonate tri (metha) acrylate, trimethylol ethane tri (metha) acrylate, trimethylol hexane tri (metha) acrylate, trimethylol octane tri (metha) acrylate, and pentaerythritol tri (metha) acrylate. Examples of monomers having four functional groups or more are, for example, pentaerythritol tetra (metha) acrylate, pentaerythritol tetra caprolactonate tetra (metha) acrylate, di-glycerin tetra (metha) acrylate, di-trimethylol propane tetra (metha) acrylate, di-trimethylol propane tetra caprolactonate tetra (metha) acrylate, di-trimethylol ethane tetra (metha) acrylate, di-trimethylol butane tetra (metha) acrylate, di-trimethylol hexane tetra (metha) acrylate, di-trimethylol octane tetra (metha) acrylate, di-pentaerythritol penta (metha) acrylate, di-pentaerythritol hexa (metha) acrylate, tri-pentaerythritol hexa (metha) acrylate, tri-pentaerythritol hepta (metha) acrylate, and tri-pentaerythritol octa (metha) acrylate.

Alkylene oxide adduct (metha) acrylate monomers of fatty acid alcohol compounds, in particular, alkylene oxide adduct (metha) acrylate monomers of fatty acid alcohol compounds having alkylene oxide of C3 to C20 or more are improved in solubility in the aforementioned resins, vegetable oils or fatty acid esters thereof. An example of alkylene oxide adduct (metha) acrylate monomer of a fatty acid alcohol compound is, for example, mono- or poly (1 to 20)-alkylene (C2 to C20) oxide adduct (examples of alkylene oxide are, for example, ethylene oxide, propylene oxide, butylene oxide, pentylene oxide, hexylene oxide and the like) mono or poly (1 to 10) (metha) acrylate of a fatty acid alcohol compound. Examples of monomer having one functional group are, for example, alkyl (the number of carbon atoms is 1 to 18) (metha) acrylate, for example, mono-or poly (1 to 20) alkylene (C2 to C20) oxide adduct (examples of alkylene oxide are, for example, ethylene oxide, propylene oxide, and butylene oxide) (metha) acrylate of methanol, ethanol, propanol, buthanol, hexanol, and octanol, furthermore, poly (1 to 20) alkylene (C2 to C20) oxide adduct (examples of alkylene oxide are, for example, ethylene oxide, propylene oxide, and butylene oxide) (metha) acrylate of butyl phenol, octyl phenol or nonyl phenol or dodecyl phenol. Examples of monomers having two functional groups are, for example, mono-or poly (1 to 20)-alkylene (C2 to C20) oxide adduct (examples of alkylene oxide are, for example, ethylene oxide, propylene oxide, and butylene oxide) di (metha) acrylate of ethylene glycol, diethylene glycol, propylene glycol, and butylene glycol; hydroxy pivaryl hydroxypivarate poly (2 to 20) alkylene (C2 to C20) oxide adduct (examples of alkylene oxide are, for example, ethylene oxide, propylene oxide, and butylene oxide) di (metha) acrylate of ethylene glycol, di-ethylene glycol, propylene glycol, and butylene glycol; hydroxy pivaryl hydroxypivarate dicaprolactonate poly (2 to 20) alkylene (C2 to C20) oxide adduct (examples of alkylene oxide are, for example, ethylene oxide, propylene oxide, and butylene oxide) di (metha) acrylate of ethylene glycol, di-ethylene glycol, propylene glycol, and butylene glycol; and 1,6-hexanediol poly (2 to 20) alkylene (C2 to C20) oxide adduct (examples of alkylene oxide are, for example, ethylene oxide, propylene oxide, and butylene oxide) di (metha) acrylate, of ethylene glycol, di-ethylene glycol, propylene glycol, and butylene glycol. Examples of monomers having three functional groups are, for example, glycerin poly (2 to 20) alkylene (C2 to C20) oxide adduct (examples of alkylene oxide are, for example, ethylene oxide, propylene oxide, and butylene oxide) tri (metha) acrylate; trimethylol propane poly (2 to 20) alkylene (C2 to C20) oxide adduct (examples of alkylene oxide are, for example, ethylene oxide, propylene oxide, and butylene oxide) tri (metha) acrylate; trimethylol ethane poly (2 to 20) alkylene (C2 to C20) oxide adduct (examples of alkylene oxide are, for example, ethylene oxide, propylene oxide, and butylene oxide) tri (metha) acrylate; and pentaerythritol poly (2 to 20) alkylene (C2 to C20) oxide adduct (examples of alkylene oxide are, for example, ethylene oxide, propylene oxide, and butylene oxide) tri (metha) acrylate. Examples of monomers having four or more functional groups are, for example, pentaerythritol poly (2 to 20) alkylene (C2 to C20) oxide adduct (examples of alkylene oxide are, for example, ethylene oxide, propylene oxide, and butylene oxide) tetra (metha) acrylate; di-glycerin poly (2 to 20) alkylene (C2 to C20) oxide adduct (examples of alkylene oxide are, for example, ethylene oxide, propylene oxide, and butylene oxide) tetra (metha) acrylate; di-glycerin poly (2 to 20) alkylene oxide (for example, ethylene oxide, propylene oxide, butylene oxide and the like) adduct tetra (metha) acrylate; di-trimethylol propane poly (2 to 20) alkylene (C2 to C20) oxide adduct (examples of alkylene oxide are, for example, ethylene oxide, propylene oxide, and butylene oxide) tetra (metha) acrylate; di-trimethylol propane poly (2 to 20) alkylene oxide (for example, ethylene oxide, propylene oxide, butylene oxide and the like) tetra (metha) acrylate; di-trimethylol propane tetra-caprolactonate tetra (metha) acrylate; di-trimethylol ethane poly (2 to 20) alkylene (C2 to C20) oxide adduct (examples of alkylene oxide are, for example, ethylene oxide, propylene oxide, and butylene oxide) tetra (metha) acrylate; di-trimethylol ethane poly (2 to 20) alkylene oxide (for example, ethylene oxide, propylene oxide, and butylene oxide and the like) tetra (metha) acrylate; di-pentaerythritol poly (2 to 20) alkylene (C2 to C20) oxide adduct (examples of alkylene oxide are, for example, ethylene oxide, propylene oxide, and butylene oxide) hexa (metha) acrylate; (propylene oxide, butylene oxide, and the like) hexa (metha) acrylate; di-pentaerythritol hexa caprolactonate poly (2 to 20) alkylene (C2 to C20) oxide adduct (examples of alkylene oxide are, for example, ethylene oxide, propylene oxide, and butylene oxide) hexa (metha) acrylate; tri-pentaerythritol poly (2 to 20) alkylene (C2 to C20) oxide adduct (examples of alkylene oxide are, for example, ethylene oxide, propylene oxide, and butylene oxide) hepta (metha) acrylate; tri-pentaerythritol poly (2 to 20) alkylene (C2 to C20) oxide adduct (examples of alkylene oxide are, for example, ethylene oxide, propylene oxide, and butylene oxide) octa (metha) acrylate; tri-pentaerythritol poly (2 to 20) alkylene (C2 to C20) oxide adduct (examples of alkylene oxide are, for example, ethylene oxide, propylene oxide, and butylene oxide) hexa (metha) acrylate; tri-pentaerythritol poly-alkylene oxide hepta (metha) acrylate; and tri-pentaerythritol poly (2 to 20) alkylene (C2 to C20) oxide adduct (examples of alkylene oxide are, for example, ethylene oxide, propylene oxide, and butylene oxide) octa (metha) acrylate.

Examples of (metha) acrylic oligomers are, for instance, esters of the aforementioned polyols, the aforementioned polybasic acids and (metha) acrylic acids, and furthermore, epoxy acrylate.

Still furthermore, hybrid compounds, that is, hybrid compounds having together oil-soluble fatty acids or oil-soluble cyclic compound group and acryloyl group, may be used. When the esterification process is carried out between a mixture of polyol and cyclic monobasic acid and/or the aforementioned fatty acids having 4 to 36 carbon atoms, and (metha) acrylic acid, first, the mixture of polyol and cyclic monobasic acid and/or the aforementioned fatty acids having 4 to 36 carbon atoms are introduced into a four-necked flask with a stirrer, or polyhydric carboxylic acid is introduced togethel Then, these are gradually heated in the presence of a reflux solvent, such as toluene, xylene, cyrohexanone, cyclohexane and the like, or without the presence of the reflux solvent, under purging with nitrogen to a temperature in the range of 80 to 260° C. and allowed to react until the acid value (milligrams of potassium hydroxide required to neutralize acid contained in 1 grams of sample) becomes 5 or less, desirably 2 or less. As the polyol, the aforementioned polyols can be cited.

Examples of the cyclic monobasic acids that can be used are, for example, benzoic acid, methyl benzoic acid (naphthoic acid), (tertially) butyl benzoic acid, naphthoic acid, (ortho) benzoylbenzoic acid, naphthenic acid, the aforementioned rosins, and tricyclodecanmonocarboxylic acid. Furthermore, fatty acid dimmers such as tung oil dimmer fatty acid, linseed oil dimmer fatty acid, soybean oil dimer fatty acid and the like, and dihydric carboxylic acids such as polymerized rosins, dodesenyl succinic anhydride, penta-decenyl succinic anhydride and the like. When these fatty acids that have 4 to 36 carbon atoms are unsaturated fatty acids, the obtained hybrid compounds become hybrid curable compounds that have together oxidative polymerizability and activation energy beam curability. When these are used as the curable compositions of the present invention, these may give more preferable curability. Thereafter, in the temperature range of 80 to 120° C., the aforementioned polymerization inhibitor is introduced, (metha) acrylic acid and the aforementioned esterification catalyst are introduced, followed by the aforementioned conventional process.

Metallic dryers may be used. As the metallic dryers, metal salts, such as, for instance, calcium salt, cobalt salt, lead salt, iron salt, manganese salt, zinc salt and zirconium salt of organic carboxylic acids, such as acetic acid, propionic acid, butyric acid, isopentanoic acid, hexanoic acid, 2-ethylbutyric acid, naphthenic acid, octyl acid, nonanoic acid, decanoic acid, 2-ethylhexanic acid, isooctanic acid, isononanic acid, lauric acid, palmitic acid, stearic acid, oleic acid, linoleic acid, neodecanoic acid, tall oil fatty acid, linseed oil fatty acid, soybean oil fatty acid, dimethyl hexanoic acid, 3,5,5-trimethyl hexanoic acid, dimethyl octanoic acid, these being well known and publicly used compounds, may be used. In order to accelerate the curing of printed ink surface and interior thereof, a plurality of these may be used together.

Radical polymerization initiators that may be used are largely divided into two types of light cleavage type and hydro-drawing type. Examples of the former type include, for example, benzoin-based compounds, such as benzoin, benzoin methyl ether, benzoin isopropyl ether and α-benzoin acrylate; benzil; 2-methyl-2-morpholino (4-methylthiophenyl) propane-1-on (commercially available from Ciba Specialty Chemicals Co., under the trade name of Irgacure 907); 2-benzyl-2-dimethylamino-1-(4-morpholinophenyl)-1-butanone (commercially available from Ciba Specialty Chemicals Co., under the trade name of Irgacure 369); benzil methyl ketal (commercially available from Ciba Specialty Chemicals Co., under the trade name of Irgacure 651); 1-hydroxycyclohexyl phenyl ketone (commercially available from Ciba Specialty Chemicals Co., under the trade name of Irgacure 184); 2-hydroxy-2-methyl-1-phenylpropane-1-on (commercially available from Merk Chemicals Co,. under the trade name of Darocure 1173); 1-(4-isopropylphenyl)-2-hydroxy-2-methylpropane-1-on (commercially available from Merk Chemical Co. under the trade name of Darocure 1116); 4-(2-hydroxyethoxy) phenyl-(2-hydroxy-2-propyl) ketone; 4-(2-acriloyl-oxyethoxy) phenyl-2-hydroxy-2-propyl ketone; diethoxyacetophenone (commercially available from Ciba Specialty Chemicals Co. under the trade name of ZL13331); Esacure KIP100 (commercially available from Fratelli-Lamberti Co.); Lucirin TPO (BASF); bis (2,6-dimethoxybenzoyl)-2,4,4-trimethyl-pentylphosphine oxide (commercially available from Ciba Specialty Chemicals Co. under the trade name of BAPOI); bis (2,4,6-trimethylbenzoyl)-phenylphosphine oxide (commercially available from Ciba Specialty Chemicals Co. under the trade name of BAPO2); BTTB (Nihon Yushi Co.); and CGI1700 (commercially available from Ciba Specialty Chemicals Co.).

Examples of the latter of the radical polymerization initiator include, for example, aryl ketone group based initiators such as benzophenone, p-methylbenzophenone, p-chlorobenzophenone, tetra-chlorobenzophenone, benzoyl methyl benzoate, 4-phenyl benzophenone, hydroxybenzophenone, 4-benzoyl-4′-methyl-diphenyl sulfide, 2-isopropylthioxanthone, 2,4-dimethylthioxanthone, 2,4-diethylthioxanthone, 2,4-dichlorothioxanthone, acetophenone and the like; dialkylamino aryl ketone based initiators such as 4,4′-bis (diethylamino) benzophenone, p-dimethylaminoisoamyl benzoate, p-dimethylaminoacetophenone and the like; and poly-cyclic carbonyl based initiators of thioxanthone type, xanthone type and halogen substituted type thereof. These initiators may be used alone or in appropriate combinations. These initiators can be used in the composition in the range of 0.1 to 30% by weight, preferably in the range of 1 to 15% by weight.

As coloring agents, inorganic or organic ones may be used. Examples of the inorganic pigment include, for example, chrome yellow, zinc yellow, Prussian blue, barium sulfate, cadmium red, titanium oxide, zinc oxide, iron oxide red, alumina white, calcium carbonate, ultramarine blue pigment, carbon black, graphite, and aluminum powder. Examples of the organic pigment include, for example, well known and well used ones such as soluble azo pigments based on 8-naphthol, 8-oxynaphthoic acid, anilide based on 3-oxynaphthoic acid, acetoacetic acid anilide and pyrazolone; insoluble azo pigments based on β-naphthol, anilide based on /3-oxynaphthoic acid, monoazo based on acetoacetic acid anilide, disazo based on acetoacetic acid anilide and pyrazolone; phthalocyanine based pigments such as copper phthalocyanine blue, halogenated (chlorinated or brominated) copper phthalocyanine blue, sulfonated copper phthalocyanine blue and metal free phthalocyanine; and polycyclic and heterocyclic pigments based on such as quinacridone, dioxazine, threne (pyranthrone, anthanthrone, indanthrone, anthrapyrimidine, flavanthrone, thioindigo, anthraquinone, perinone, perilene and the like), isoindolinone, metal complex, quinophthalone and the like.

In the present invention, solvents for use in printing ink having boiling point in the range of 200 to 400° C. including volatile organic compounds (VOCs) such as conventional petroleum based solvents may be used.

Examples of solvent for use in printing ink are, for example, Spindle oil No.1, Solvents Nos. AF3 to 8, Naphtesol H, Alkene 56NT that are produced by Nippon Petro Chemicals; Diadol 13 and Diyaren 168 produced by Mitubishi Chemical Co.; and Fine Oxsocol and Fine Oxsocol 180 produced by Nissan Chemical Co.

In the following, use modes of the curable compositions according to the present invention will be described in detail.

The curable compositions of the present invention can be used as printing ink or overprint varnish (OP varnish). In the case of the printing ink, although the ink is usually used in the form of lithographic ink, it can be used also as letter press ink used in rotary letter press printing and flexo graphic ink in the relief printing. Typical composition ratio is as follows:

Polymer consisting of aromatic vinyl compound and α,β-unsaturated carboxylic acid ester: 1 to 40% by weight

Vegetable oil and/or fatty acid ester thereof: 5 to 40% by weight

Resin having a softening point in the range of 50 to 180° C.: 1 to 40% by weight

Monomer or oligomer having ethylenically unsaturated double bond: 5 to 90% by weight

Coloring agent: 0 to 30% by weight

Hybrid compound: 0 to 30% by weight

Radical polymerization inhibitor: 0.01 to 1% by weight

Radical polymerization initiator: 0 to 15% by weight

Metallic dryer: 0.1 to 3.0% by weight

Other additives: 0 to 10% by weight

Solvent for use in printing ink: 0 to 40% by weight

In addition, when the curable composition of the present invention is used as the printing ink, the curable composition is desirably formed into a varnish having viscosity (100 to 300 Pa·s at 25° C.) easy to apply in the printing.

The varnish is prepared according to, for instance, the following procedure. That is, a mixture of a resin having a softening point in the range of 50 to 180° C. and a vegetable oil or a fatty acid ester thereof is dissolved or cooked at a temperature in the range of 180 to 260° C. for 0.5 to 3 hrs, followed by cooling to 180° C., further followed by introducing a polymer of an aromatic vinyl compound and α,β-unsaturated carboxylic acid and dissolving these, after 30 min, further followed by, while introducing (metha) acrylic monomer or (metha) acrylic oligomer having ethylenically unsaturated double bond and a polymerization inhibitor, dissolving at a temperature in the range of 80 to 120° C. After such processes, for instance, a varnish having viscosity in the range of 50 to 300 Pa·s at 25° C. may be obtained. As needs arise, a hybrid compound of the present invention may be added to the varnish. In the manufacturing process of the curable compositions according to the present invention, as needs arise, purging with air, addition of nitrogen gas and the polymerization inhibitor, or addition of an antioxidant may be performed together.

As the polymerization inhibitor, the aforementioned ones can be cited.

As the additives, for instance, anti-friction agent, anti-blocking agent, slipping agent, and anti-scratch agent may be used. As the anti-scratch agent, natural waxes, such as carnauba wax, Japan wax, lanoline, montan wax, paraffin wax and microcrystalline wax, and synthetic waxes such as Fischer-Tropsch wax, polyethylene wax, poly propylene wax, poly tetrafluoroethylene wax, polyamide wax and silicone compounds may be used.

Furthermore, the varnish may be allowed to form a gel varnish with a gelling agent. As the gelling agents, usually aluminum complex compounds can be cited. As aluminum alcoholates, aluminum isopropylate (commercially available from Kawaken Fine Chemicals Co. Ltd. under the trade name AIPD) and aluminum isopropylate-mono-sec-butylate (commercially available from Kawaken Fine Chemical Co. Ltd. under the trade name AMD) can be cited. As aluminum alkylacetates, for instance, aluminum-di-iso-butoxide-ethylacetoacetate (commercially available from Hope Pharmaceutical Co. Ltd. under the trade name Chelope A1-EB2), aluminum-di-iso-propoxide-ethylacetoacetate (commercially available from Hope Pharmaceutical Co. Ltd. under the trade name Chelope A1-EP2 and Kawaken Fine Chemicals Co. Ltd. under the trade name ALch), aluminum tris (acetyl acetonate) (commercially available from Kawaken Fine Chemicals Co. Ltd. under the trade name ALCH-TR), aluminum tris (acetyl acetoacetate) (commercially available from Kawaken Fine Chemicals Co. Ltd. under the trade name Alumichelate A), aluminum-bis-(ethylacetylacetonate)-monoacetylacetonate (commercially available from Kawaken Fine Chemicals Co. Ltd. under the trade name Alumchelate D), Alumichelate M (commercially available from Kawaken Fine Chemicals Co. Ltd.), and liquid oleap AOS (commercially available from Hope Pharmaceutical Co. Ltd.) can be cited. As Aluminum soaps, aluminum stearate (available from Nihon Yushi K.K.), aluminum olate, aluminum naphthonate, aluminum urate and aluminum acetylacetonate can be cited. These gelling agents are used in the range of 0.1 to 10 parts by weight to 100 parts by weight of varnish. The gel varnish can be obtained by, after introducing 0.1 to 3 parts by weight of the gelling agent, allowing to react at a temperature in the range of 100 to 200° C. for 30 min to 2 hrs.

The printing ink can be prepared by processing, between a room temperature and 100° C., printing ink components such as a coloring agent, a varnish and/or a gel varnish thereof, the hybrid compound of the present invention, a vegetable oil or fatty acid thereof, (metha) acrylic monomer or (metha) acrylic oligomer having ethylenically unsaturated double bond, a radical polymerization inhibitor, a radical polymerization initiator and/or a sensitizer, a metallic dryer and other additives by use of kneading, mixing and conditioning apparatuses such as a kneader, a three-roll mill, an attritor, a sand mill, a gate mixer and the like.

Although the curable ink made of the curable composition of the present invention is used in the offset printing that usually uses a dampening solution, it can be preferably used also in water-less printing in which the dampening solution is not used. Furthermore, the curable compositions of the present invention can be applied also to an overprint varnish (commonly called as OP varnish). The curable compositions and curable inks of the present invention can be applied to various kinds of printed matter such as printed matter for use in office form, printed matter for various kinds of books, printed matter for various kinds of wrappings such as carton paper and the like, various kinds of plastic printed matter, printed matter for use in seal and label, art prints, metal printed matter (art prints, printed matter for use in drink canister, printed matter for use in food such as canned food) and the like. The curable inks can be used as UV light curable ink and electron beam curable ink. The curable overcoat varnishes can be used as UV light curable ink and electron beam curable ink, and furthermore may be used in some cases as aqueous overcoat varnish.

Furthermore, the present invention provides a printing method and a printed matter that is obtained by use of the printing method. In the present printing method, in order to further improve aesthetic high-grade feeling and durability of the printed matter that is obtained by use of the curable ink of the present invention, the following procedure is taken. That is, the curable ink is printed on a substrate, and immediate thereafter, an activation energy beam curable overcoat varnish is coated in a wet state followed by irradiating the activation energy beam thereon. Usually when a general oil-based ink that has oxidative polymerizability alone is printed followed by coating an activation energy beam curable overcoat varnish and irradiating an activation energy beam thereon, when gloss is measured after several days, initial gloss is not maintained and deteriorates. That is, the so-called gloss-back occurs. However, when the curable ink of the present invention is used, even when the activation energy beam curable overcoat varnish is immediately coated thereon after printing the ink and followed by irradiating the activation energy beam thereon, since the gloss-back can be remarkably improved, the printed matter having aesthetic high-grade feeling can be provided. As substrate, coat board paper such as Maricoat, Polyethylene-coat paper, aluminum coated paper (available from Hokuetsu Paper Mills Ltd.), thin coat paper such as Art Paper and high-grade Paper, synthetic paper, plastic film, metal plate and the like (available from Mitubishi Paper Mills Ltd.) can be used.

### EXAMPLES

In the following, the present invention will be further detailed based on examples. In the examples that follow, “part” means “part by weight” when no other meanings are shown.

Preparation of Polymerized Compounds

Into a four-necked flask equipped with a stirrer, a condenser and a thermometer, 154 parts of isoborneol (isobornyl alcohol), 0.2 part of hydroquinone, 20 parts of toluene, 86 parts of methacrylic acid and 2 parts of p-toluene sulfonic acid were introduced and allowed to react under purging with air at a temperature in the range of 90 to 115° C. until an acid value of 15 or less was attained. Thereafter, 12 parts of a 20% aqueous solution of sodium hydroxide was introduced to neutralize, followed by three times of water washing each time with 200 ml of water, further followed by depressurizing at a temperature of 90 to 115° C. to remove solvent, resulting in obtaining isoborneol methacrylic ester (isobornyl methacrylate). Then, 150 parts of toluene were introduced and heated to a temperature of 80° C. under purging with nitrogen, followed by dripping, over 3 hrs, a solution in which 50 parts of styrene, 50 parts of the aforementioned isoborneol methacrylic ester (isobornyl methacrylate) and 3 parts of benzoyl peroxide have previously been dissolved. When 2 hrs have passed after the completion of the dripping, 0.5 part of benzoyl peroxide was introduced and the reaction was allowed to continue for further 2 hrs, followed by solvent removal to dip out a solvent, thus resulting in a polymer P1.

Likewise, as shown in Table 1, polymers P2 to P7 were prepared. Borneol acrylic ester (bornyl acrylate) was obtained by an equimolar reaction between borneol and acrylic acid. Under the similar reaction process, terpineol methacrylic ester was obtained by an equimolar reaction between terpineol and methacrylic acid; 2-hydroxyethyl methacrylate monorosin ester was obtained by an equimolar reaction between 2-hydroxyethyl methacrylate and rosin; butyl methacrylate was obtained by an equimolar reaction between buthanol and methacrylic acid; and maleic acid di-butyl ester was obtained by a reaction between one mole of maleic acid and two moles of buthanol.

TABLE 1

| | | Polymers of examples | | | | | | |
|---|---|---|---|---|---|---|---|---|
| | Raw | Polymer | Polymer | Polymer | Polymer | Polymer | Polymer | Polymer |
| Item | Material | P1 | P2 | P3 | P4 | P5 | P6 | P7 |
| Solvent | Toluene | 150 | | | | 150 | | |
| | Ethyl acetate | | 120 | | | | 150 | |
| | Methylethyl | | | 150 | | | | 150 |
| | ketone | | | | | | | |
| | Isopropyl | | | | 150 | | | |
| | alcohol | | | | | | | |
| Aromatic | Styrene | 50 | 70 | 80 | 80 | 50 | 80 | |
| vinyl | Vinyl toluene | | | | | | | 70 |
| Acrylic | Isoborneol | 50 | 20 | | | | | |
| ester | methacrylic | | | | | | | |
| | ester | | | | | | | |
| | Borneol acrylic | | | 10 | | | | |
| | ester | | | | | | | |
| | Terpineol | | | | 20 | | | |
| | methacrylic | | | | | | | |
| | ester | | | | | | | |
| | 2-HEMARO | | | | | 50 | | |
| | Butyl | | 10 | 10 | | | 20 | |
| | methacrylate | | | | | | | |
| | Maleic acid | | | | | | | 30 |
| | dibutyl ester | | | | | | | |
| Thermal | Benzoyl | 3 | 3 | | | 3 | 3 | |
| polymer- | peroxide | | | | | | | |
| ization | Azobisisobutyl | | | 3 | 3 | | | 3 |
| initiator | o nitrile | | | | | | | |
| Additional | Benzoyl | 0.5 | 0.5 | | | 0.5 | 0.5 | |
| thermal | peroxide | | | | | | | |
| polymer- | Azobisisobutyl | | | 0.5 | 0.5 | | | 0.5 |
| ization | o nitrile | | | | | | | |
| initiator | | | | | | | | |
| Reaction | Reaction | 80° C. | 80° C. | 90° C. | 90° C. | 80° C. | 80° C. | 90° C. |
| temper- | temperature | | | | | | | |
| ature | | | | | | | | |
| Specifi- | Acid value | 0.5 | 1 | 0.8 | 0.7 | 0.5 | 0.3 | 0.3 |
| cation | (KOH mg/g) | | | | | | | |
| | Weight average | 1.7 | 1.8 | 2.0 | 1.5 | 1.2 | 1.2 | 2.5 |
| | molecular | | | | | | | |
| | weight(× 10⁴) | | | | | | | |
| | Softening | 90 | 100 | 100 | 95 | 100 | 90 | 105 |
| | temperature | | | | | | | |
| | (° C.) | | | | | | | |

2-HEMARO: 2-hydroxyethyl methacrylate monorosin ester

Preparation of Resins Having Softening Point in the Range of 50 to 180° C.

(Resin R1: Rosin Phenolic Resin)

[Synthesis of Resol Phenolic Resin]

Into a four-necked flask with a stirrer, a reflux condenser and a thermometer, 206 parts of p-octylphenol, 203 parts of 37% formalin and 250 parts of xylene were introduced, heated and stirred while purging with a nitrogen gas, and a dispersion liquid, which has been separately prepared by dispersing 2.0 parts of calcium hydroxide in 10 parts of water at 50° C., was introduced therein followed by heating to 95° C. and allowing to react at the same temperature for 3.5 hrs. Thereafter, after cooling, neutralizing with sulfuric acid and water-washing were performed. A resol xylene solution layer and an aqueous layer were left at rest to separate. This resol phenolic resin was used as a resol liquid.

[Preparation of Rosin Phenolic Resin]

Into a four-necked flask with a stirrer, a reflux condenser with a water separator, and a thermometer, under the purge with a nitrogen gas, 60 parts of rosin were introduced, heated and stirred, followed by introducing, by dripping, 40 parts (as a solid component) of the resol liquid at 200° C. over substantially 2 hrs, during which while recovering water and xylene the reaction was allowed to proceed. After the introduction was over, the temperature was raised, and at 250° C. 6.0 parts of glycerin was introduced and allowed to react for 12 hrs. When the acid value has become 25 or less, it was drained out. A weight average molecular weight of the present resin was 45,000 (Resin R1).

Please note that an amount of the resol liquid that reacts with the rosin is shown by weight of a solid component, and that a weight average molecular weight was measured by use of a gel-permeation chromatography (commercially available from TOSO Co. under the trade name HLC8020) with polystyrene as a reference sample for use in working curve.

(Resin R2: α,β-Ethylenically Unsaturated Carboxylic Acid Ester-Modified Petroleum Resin)

Into a flask with a stirrer, a reflux condenser and a thermometer, 470 parts of dicyclopentadiene resin (MARUKAREZ M510A (available from Maruzen Petrochemical Co. Ltd.): a ratio by weight of dicyclopentadiene to pentadiene is 4/1) and 30 parts of maleic anhydride were introduced and heated to elevate the temperature to 180° C. while purging with a nitrogen gas, followed by allowing to react at 180° C. for 3 hrs, thus maleic acid anhydride-modified DCPD resin (MD resin) was obtained. Next, into a flask with a stirrer, a reflux condenser with a water separator, and a thermometer, 300 parts of the MD resin and 20 parts of butylethylpropanediol (BEPD) were introduced and heated to elevate the temperature to 250° C. while purging with a nitrogen gas, followed by allowing to react at 250° C. for 3 hrs. Thus, resin R2 that has an acid value of 10, a melting point of 140° C., and a weight average molecular weight (hereinafter referred to as Mw) due to the gel permeation chromatography (hereinafter referred to as GPC) of 44,000 was obtained.

(Resin R3: α,β-Ethylenically Unsaturated Carboxylic Acid Ester-Modified Petroleum Resin)

Into a flask with a stirrer, a reflux condenser and a thermometer, 460 parts of dicyclopentadiene resin (MARUKAREZ M905A (available from Maruzen Petrochemical Co. Ltd.): a copolymer of dicyclopentadiene, indene and styrene) and 37 parts of maleic anhydride were introduced and heated to elevate the temperature to 180° C. while purging with a nitrogen gas followed by allowing to react at 180° C. for 5 hrs, thus maleic anhydride-modified DCPD resin (AD-4) was obtained. Next, into a flask with a stirrer, a reflux condenser with a water separator, and a thermometer, 300 parts of AD-4, 28 parts of BEPD and 15 parts of dodecenyl succinic anhydride were introduced and heated to elevate the temperature to 250° C. while purging with a nitrogen gas followed by allowing to react at 250° C. for 5 hrs. Thus, hydrocarbon resin R3 that has an acid value of 10, a melting point of 130° C., and a Mw of 52,000 was obtained.

(Resin R4: α,β-Ethylenically Unsaturated Carboxylic Acid-Modified Rosin Ester Resin)

Into a four-necked flask with a stirrer, a water separator and a thermometer, 93 parts of polymerized rosin (Dymarex (available from Rika-Hercules Co. Ltd) contains rosin dimmer by 80%) and 7 parts of maleic anhydride were introduced and allowed to react according to Diels-Alder reaction under nitrogen gas purge at 180° C. for 2 hrs. Thereafter, 18 parts of trimethylol octane was introduced, followed by gradually heating and elevating the temperature to 270° C. and allowing to react until an acid value became 25 or less, followed by draining out. A weight average molecular weight of the present resin was 65,000 (resin R4).

(Resin R5: α,β-Ethylenically Unsaturated Carboxylic Acid-Modified Rosin Ester Resin)

Into a four-necked flask with a stirrer, a water separator and a thermometer, 93 parts of polymerized rosin 2 (Dymarex (available from Rika-Hercules Co. Ltd) contains rosin dimmer by 80%) and 7 parts of maleic anhydride were introduced and allowed to react according to Diels-Alder reaction under nitrogen gas purge at 180° C. for 2 hrs. Thereafter, 17.5 parts of pentaerythritol and 18.5 parts of octyl acid were introduced, followed by gradually heating and elevating the temperature to 250° C. and allowing to react until an acid value thereof became 25 or less, followed by draining out. A weight average molecular weight of the present resin was 60,000 (resin R5).

(Resin R6: Rosin and Petroleum Resin-Modified Ester Resin)

Into a four-necked flask with a stirrer, a water separator and a thermometer, 53 parts of gum rosin, 40 parts of MARUKAREZ M510 (available from Maruzen Petrochemical Co. Ltd.) and 7 parts of maleic anhydride were introduced and allowed to react according to Diels-Alder reaction under nitrogen gas purge at 180° C. for 2 hrs. Thereafter, 17.5 parts of pentaerythritol and 18.5 parts of nonyl acid were introduced, followed by gradually heating and elevating the temperature to 250° C. and allowing to react until an acid value thereof became 25 or less, followed by draining out. A weight average molecular weight of the present resin was 45,000 (resin R6).

(Resin R7: Rosin Alkyd Resin)

Into a four-necked flask with a stirrer, a water separator and a thermometer, 73.1 parts of rosin was introduced, followed by introducing 14.2 parts of pentaerythritol under nitrogen gas purge at 240° C. and allowing to react at 270° C. until an acid value thereof became 20 or less. Thereafter, 12.7 parts of isophthalic acid was gradually introduced at the same temperature, followed by allowing reacting until an acid value became 20 or less. A weight average molecular weight of the present resin was 65,000 (resin R7).

Preparation of Hybrid Compound HR

(Compound HR1)

Into a four-necked flask with a stirrer, a water separator and a thermometer, 266 parts of linseed oil fatty acid, 134 parts of trimethylol propane, 6 parts of p-toluene sulfonic acid, and 40 parts of toluene were introduced, followed by gradually raising the temperature under nitrogen gas purge, further followed by allowing to react at 110° C. for 9 hrs. When an acid value became 5 or less, 0.6 parts of methoquinone and 137 parts of acrylic acid were introduced, followed by allowing to react under nitrogen gas purge at 110° C. After substantially 7 hrs when a dehydration reaction was over, 20 parts of cyclohexane were introduced, further followed by allowing continuing deydration under reflux until an acid value became 10.0. Thereupon, the product was water washed three times with an equal amount of water, and when cleaning water was found to be neutral or so by means of litmus paper, solvent removal process was performed followed by draining out. The acid value thereof was 2.0.

(Compound HR2)

Into a four-necked flask with a stirrer, a water separator and a thermometer, 287 parts of rosin, 134 parts of trimethylol propane, and 40 parts of toluene were introduced, gradually heated under nitrogen gas purge, and allowed to react at 270° C. for 7 hrs. When an acid value thereof became 5 or less, the temperature was lowered to 110° C., 0.6 parts of methoquinone, 6 parts of p-toluene sulfonic acid and 137 parts of acrylic acid were introduced and allowed to react under nitrogen gas purge at 110° C. After substantially 8 hrs when a dehydration reaction was over, 20 parts of cyclohexane was introduced followed by allowing continuing dehydration under reflux until an acid value became 10.0. Thereupon, the product was water washed three times with an equal amount of water, and when cleaning water was found to be neutral or so by means of litmus paper, solvent removal process was conducted followed by draining out. The acid value was 4.0.

Varnish Preparation

(Varnishes V1 to V5, and V7: Preparation of Resin Varnish)

Into a four-necked flask with a stirrer, a cooler with a water separator and a thermometer, 20 parts of resin (R1) and linseed oil were introduced and heated under nitrogen gas purge at 220° C. for 1 hr. Thereafter, 20 parts of the above polymer P1 of example was introduced at 180° C., and after stirring for 30 min, the temperature was lowered to 110° C., and 0.1 parts of t-BHQ (tertially butyl hydroquinone) and 34.9 parts of ditrimethylol propane tetraacrylate were introduced followed by stirring for 30 min. Thereby, the viscosity was adjusted to be 150 to 200 Pa * s at 25° C., followed by draining out (Varnish V1). Likewise, varnishes V2 to V5, and V7 were prepared.

(Varnish V6)

Into a four-necked flask with a stirrer, a cooler with a water separator and a thermometer, 20 parts of resin (R6) and 20 parts of soybean oil were introduced, heated and dissolved under purge with nitrogen gas, after keeping at 220° C. for 1 hr, the temperature was lowered to 160° C., and 0.5 parts of ALCH (a gelling agent that is available from Kawaken Fine Chemicals Co. Ltd.) were added, followed by keeping at 190° C. for 1 hr. Thereafter, according to recipe of Varnish V6 shown in Table 2 and the process of Varnish 1, another varnish was prepared (Varnish 6).

TABLE 2

| | | Varnishes of examples | | | | | | |
|---|---|---|---|---|---|---|---|---|
| | | V1 | V2 | V3 | V4 | V5 | V6 | V7 |
| Resin | Resin R1 | 20 | | | | | | |
| | Resin R2 | | 20 | | | | | |
| | Resin R3 | | | 20 | | | | |
| | Resin R4 | | | | 20 | | | |
| | Resin R5 | | | | | 20 | | |
| | Resin R6 | | | | | | 20 | |
| | Resin R7 | | | | | | | 20 |
| Vegetable | Linseed oil | 25 | 25 | 25 | 25 | | | |
| Oil | Soybean oil | | | | | 25 | 24.5 | |
| | Linseed oil | | | | | | | 23 |
| | FAB | | | | | | | |
| Gelling | Gelling | | | | | | 0.5 | |
| Agent | agent | | | | | | | |
| Polymer | Polymer P1 | 20 | | | | | | |
| | Polymer P2 | | 20 | | | | | |
| | Polymer P3 | | | 20 | | | | |
| | Polymer P4 | | | | 20 | | | |
| | Polymer P5 | | | | | 20 | | |
| | Polymer P6 | | | | | | 20 | |
| | Polymer P7 | | | | | | | 20 |
| Polymer- | T-BHQ | 0.1 | 0.1 | 0.1 | 0.1 | 0.1 | 0.1 | 0.1 |
| ization | | | | | | | | |
| Inhibitor | | | | | | | | |
| Monomer | M1 | 34.9 | 34.9 | 20 | | | | 20 |
| | M2 | | | | 15 | | | |
| | M3 | | | | 10 | 10 | 10 | |
| | M4 | | | | | 15 | | |
| | M5 | | | | | | 15 | |
| | M6 | | | 14.9 | | | | 14.9 |
| | M7 | | | | | | 9.9 | |
| Hybrid | HR1 | | | | 9.9 | | | |
| Intermediate | HR2 | | | | | 9.9 | | |

| | | Varnishes of examles | | |
|---|---|---|---|---|
| | | V8 | V9 | V10 |
| Polymer | Polymer P1 | 43 | | |
| | Polymer P2 | | 43 | |
| | Polymer P3 | | | 42 |
| | Polymer P4 | | | |
| | Polymer P5 | | | |
| | Polymer P6 | | | |
| | Polymer P7 | | | |
| Vegetable | Linseed oil | 22 | 22 | 22 |
| Oil | Soybean oil | | | |
| | Linseed oil | | | |
| | FAB | | | |
| Gelling | Gelling | | | 1 |
| Agent | agent | | | |
| Polymer- | T -BHQ | 0.1 | 0.1 | 0.1 |
| ization | | | | |
| Inhibitor | | | | |
| Monomer | M1 | 34.9 | 34.9 | 20 |
| | M2 | | | |
| | M3 | | | |
| | M4 | | | |
| | M5 | | | |
| | M6 | | | 14.9 |
| | M7 | | | |
| Hybrid | HR1 | | | |
| Intermediate | HR2 | | | |

Linseed oil FAB: Linseed oil fatty acid butyl ester
Gelling Agent: ALCH (produced by Kawaken Fine Chemicals)
t-BHQ: tertially butyl hydroquinone
Monomer M1: di-trimethylol propane tetraacrylate
Monomer M2: di-pentaerythritol hexaacrylate
Monomer M3: trimethylol propane triacrylate
Monomer M4: pentaerythritol tetraacrylate
Monomer M5: bisphenol A tetraethylene oxide adduct diacrylate
Monomer M6: trimethylol propane tripropylene oxide adduct triacrylate
Monomer M7: neopentylglycol dipropylene oxide adduct diacrylate

(Comparative Varnishes V8 to V10: Oxidative Polymerization Varnish)

Into a four-necked flask with a stirrer, a condenser with a water separator, and a thermometer, under purge with nitrogen gas, 45 parts of rosin modified phenolic resin R1, 20 parts of linseed oil, 34.4 parts of AF5 solvent (aroma-free ink solvent available from Nihon Petrochemicals), 0.5 parts of ALCH (gelling agent available from Kawaken Fine Chemicals Co. Ltd.), and 0.1 parts of t-BHQ (tertially butyl hydroquinone) were introduced, heated and dissolved at 200° C. for 1 hr. When the viscosity was measured by use of Cone and Plate Viscometer, it was 98 Pa·s/25° C. Likewise, Varnish V9 and Varnish V10 of comparative examples were prepared according to the recipes shown in Table 3.

(Comparative Varnishes V11 and V12: Activation Energy Beam Curable Varnish)

Into a four-necked flask with a stirrer, a condenser with a water separator, and a thermometer, 30 parts of “DAP Toto” DT170 (diarylphthalate resin available from Totokasei Co. Ltd.), 69.9 parts of ditrimethylol propane tetraacrylate, and 0.1 parts of hydroquinone were introduced and dissolved under air purge at 100° C. for 30 min to 1 hr. When the viscosity was measured by use of Cone and Plate Viscometer, it was found to be 152 Pa·s/25° C. Likewise, Varnish V12 as a comparative varnish was prepared according to the recipes shown in Table 3.

TABLE 3

| | | Comparative Varnishes | | | | |
|---|---|---|---|---|---|---|
| | | V8 | V9 | V10 | V11 | V12 |
| Resin | Rosin-modified | 45 | 45 | 45 | | |
| | phenolic resin R1 | | | | | |
| | DT170 | | | | 30 | 30 |
| Vegetable | Linseed oil | 20 | | | | |
| oil | Tung oil | | 20 | | | |
| | Soy bean oil | | | 20 | | |
| Solvent | AF5 | 34.4 | 34.4 | 34.4 | | |
| Gelling | ALCH | 0.5 | 0.5 | 0.5 | | |
| agent | | | | | | |
| Monomer | M1 | | | | 69.9 | |
| | M2 | | | | | 69.9 |
| Polymer- | HQ | | | | 0.1 | 0.1 |
| ization | (hydroquinone) | | | | | |
| inhibitor | t-BHQ | 0.1 | 0.1 | 0.1 | | |

DT170: diarylphthalate resin produced by Toto Kasei Co. Ltd.
AF5: aromatic component-free ink solvent produced by Nihon Petrochemicals
t-BHQ: tertially-butyl hydroquinone

### Examples 1-15 and Comparative Examples 1-9

Preparation of Curable Ink

(Example Inks 1 through 15)

As magenta pigment, 18 parts of Carmine 6B (magenta pigment commercially available from Toyo Ink Mfg. Co. Ltd.), 49 parts of Varnish V1, 26.9 parts of ditrimethylol propane tetraacrylate, 2.5 parts of 4,4′-bis (diethylamino) benzophenone (EAB), 2.5 parts of Irgacure 907, 0.1 parts of t-BHQ (tertiallybutyl hydroquinone) and 1 part of manganese naphthate were introduced and processed according to the conventional method by use of a three-roll mill.

Ink was prepared so as to have a tack value of 7 to 8/25C. Inks 2 through 15 were prepared according to the recipes shown in Tables 4, 5 and 6. Inks 9, 10, 14 and 15 were examples of electron beam curable inks.

Ignition losses of example curable inks 1 through 10 for examples were all 0.9% (water content was 0.2%), that of example curable ink 11 was 5.8% (water content was 0.2%), and those of example curable inks 12 through 15 were 10.9% (water content was 0.2%). These values were obtained by thermogravimetric analysis in which an ignition loss under the conditions of 110° C., 1 hr and nitrogen gas flow rate of 100 mL/min was measured by use of thermal analysis equipment. The water contents were obtained by Karl Fischer's method.

TABLE 4

| | | Example Inks | | | | |
|---|---|---|---|---|---|---|
| | Raw material | Ink 1 | Ink 2 | Ink 3 | Ink 4 | Ink 5 |
| Pigment | Carmine 6B | 18 | 18 | 18 | 18 | 18 |
| Varnish | V1 | 49 | | | | |
| | V2 | | 49 | | | |
| | V3 | | | 49 | | |
| | V4 | | | | 49 | |
| | V5 | | | | | 40 |
| Monomer | M1 | 26.9 | 26.9 | 16.9 | | |
| | M2 | | | | 16.9 | |
| | M3 | | | | 10 | 10 |
| | M4 | | | | | 16.9 |
| | M5 | | | | | |
| | M6 | | | 10 | | |
| | M7 | | | | | |
| Polymer- | EAB | 2.5 | 2.5 | 2.5 | 2.5 | 2.5 |
| ization | Irgacure 907 | 2.5 | 2.5 | 2.5 | 2.5 | 2.5 |
| Initiator | | | | | | |
| Polymer- | t-BHQ | 0.1 | 0.1 | 0.1 | 0.1 | 0.1 |
| ization | | | | | | |
| Inhibitor | | | | | | |
| Metallic | Manganese | 1 | 1 | 1 | 1 | 1 |
| Dryer | naphthate | | | | | |
| Ink | Tack | 8 | 7.7 | 7.5 | 7.5 | 7.5 |
| specification | Flow | 19 | 19.1 | 19.2 | 18.7 | 18.5 |

Carmine 6B: magenta pigment produced by Toyo Ink Mfg. Co. Ltd.
Monomer M1: di-trimethylol propane tetraacrylate
Monomer M2: di-pentaerythritol hexaacrylate
Monomer M3: trimethylol propane triacrylate
Monomer M4: pentaerythritol tetraacrylate
Monomer M5: bisphenol A tetraethylene oxide adduct diacrylate
Monomer M6: trimethylol propane tripropylene oxide adduct triacrylate
Monomer M7: neopentylglycol dipropylene oxide adduct diacrylate
EAB: 4,4′-bis(diethylamino) benzophenone
t-BHQ: tertially butyl hydroquinone

TABLE 5

| | | Example Inks | | | | |
|---|---|---|---|---|---|---|
| | Raw material | Ink 6 | Ink 7 | Ink 8 | Ink 9 | Ink 10 |
| Pigment | Carmine 6B | | | | 18 | |
| | Lionol Blue | 18 | 18 | 18 | | 18 |
| | 7330 | | | | | |
| Varnish | V6 | 49 | | | | |
| | V7 | | 49 | | | |
| | V2 | | | 49 | 54 | 54 |
| Monomer | M1 | | 16.9 | 26.9 | 26.9 | 26.9 |
| | M2 | | | | | |
| | M3 | 10 | | | | |
| | M4 | | | | | |
| | M5 | 10 | | | | |
| | M6 | | 10 | | | |
| | M7 | 6.9 | | | | |
| Polymer- | EAB | 2.5 | 2.5 | 2.5 | | |
| ization | Irgacure 907 | 2.5 | 2.5 | 2.5 | | |
| initiator | | | | | | |
| Polymer- | T-BHQ | 0.1 | 0.1 | 0.1 | 0.1 | 0.1 |
| ization | | | | | | |
| inhibitor | | | | | | |
| Metallic | Manganese | 1 | 1 | 1 | 1 | 1 |
| dryer | naphthate | | | | | |
| Ink | Tack | 7 | 7.8 | 7.5 | 7.3 | 7.5 |
| specification | Flow | 19 | 19.3 | 19.2 | 18.7 | 18.5 |

Lionol Blue 7330: Cyan pigment produced by Toyo Ink Mfg. Co. Ltd.

TABLE 6

| | | Example Inks | | | | |
|---|---|---|---|---|---|---|
| | Raw | | | | | |
| | material | Ink 11 | Ink 12 | Ink 13 | Ink 14 | Ink 15 |
| Pigment | Carmine | 18 | 18 | | 18 | |
| | 6B | | | | | |
| | Lionol | | | 18 | | 18 |
| | Blue | | | | | |
| | 7330 | | | | | |
| Varnish | V1 | 50 | | | | |
| | V2 | | 52 | 52 | 57 | 57 |
| Monomer | M1 | 13.9 | 13.9 | 13.9 | 13.9 | 13.9 |
| | M2 | | | | | |
| | M3 | | | | | |
| | M4 | | | | | |
| | M5 | | | | | |
| | M6 | | | | | |
| | M7 | | | | | |
| Solvent for | AF5 | 5 | 10 | 10 | 10 | 10 |
| printing ink | | | | | | |
| Polymer- | EAB | 2.5 | 2.5 | 2.5 | | |
| ization | Irgacure | 2.5 | 2.5 | 2.5 | | |
| initiator | 907 | | | | | |
| Polymer- | T-BHQ | 0.1 | 0.1 | 0.1 | 0.1 | 0.1 |
| ization | | | | | | |
| inhibitor | | | | | | |
| Metallic | Manga- | 1 | 1 | 1 | 1 | 1 |
| dryer | nese | | | | | |
| | naphthate | | | | | |
| Ink | Tack | 7 | 7.7 | 7.6 | 7.2 | 7.6 |
| specification | Flow | 19.2 | 19.2 | 19.3 | 18.6 | 18.6 |

AF5: aromatic component-free ink solvent produced by Nihon Petrochemicals. (Oil-based Inks 16 through 18 for comparative examples)

18 parts of Carmine 6B, 70.9 parts of Varnish V8, 10 parts of AF5 solvent, 0.1 parts of t-BHQ (tertially butyl hydroquinone) and 1 part of manganese naphthate were introduced and processed by use of a three roll mill according to the conventional method. The tack value of the ink was adjusted to be 7 to 8 at 25° C.

Likewise, according to the recipe shown in Table 7, comparative example oil-based inks 17 and 18 were prepared for comparative examples.

Ignition losses of comparative example oil-based inks 16 through 18 were 35% (water content was 0.2%).

TABLE 7

| | | Comparative | | | Comparative Example | | | |
|---|---|---|---|---|---|---|---|---|
| | | Example Oil | | | Activation Energy Beam | | | |
| | | Based Ink | | | Curable Ink | | | |
| | Raw | Ink | Ink | Ink | Ink | Ink | Ink | Ink |
| | Material | 16 | 17 | 18 | 19 | 20 | 21 | 22 |
| Pigment | Carmine | 18 | 18 | | 18 | | 18 | |
| | 6B | | | | | | | |
| | Lionol | | | 18 | | 18 | | 18 |
| | Blue | | | | | | | |
| | 7330 | | | | | | | |
| Compara- | V8 | 70.9 | | | | | | |
| tive | V9 | | 70.9 | | | | | |
| Example | V10 | | | 70.9 | | | | |
| Varnish | V11 | | | | | 30 | | 35 |
| | V12 | | | | 30 | | 35 | |
| Solvent | AF5 | 10 | 10 | 10 | | | | |
| for | | | | | | | | |
| printing | | | | | | | | |
| ink | | | | | | | | |
| Monomer | M1 | | | | 26.9 | 26.9 | 26.9 | 26.9 |
| | M2 | | | | 20 | 20 | 20 | 20 |
| Polymer- | EAB | | | | 2.5 | 2.5 | | |
| ization | Irgacure | | | | 2.5 | 2.5 | | |
| initiator | 907 | | | | | | | |
| Polymer- | HQ | | | | 0.1 | 0.1 | 0.1 | 0.1 |
| ization | T-BHQ | 0.1 | 0.1 | 0.1 | | | | |
| Inhibitor | | | | | | | | |
| Metallic | Mangan- | 1 | 1 | 1 | | | | |
| dryer | ese | | | | | | | |
| | naphthate | | | | | | | |
| Ink | Tack | 7.5 | 7.2 | 7.5 | 7.5 | 7.2 | 7.5 | 7.5 |
| specifica- | Flow | 19 | 18.8 | 19.2 | 19 | 18.8 | 19.2 | 19 |
| tion | | | | | | | | |

(UV Curable Inks 19 and 20 for comparative examples)

18 parts of Carmine 6B, 30 parts of Varnish V11, 26.9 parts of ditrimethylol propane tetraacrylate, 20 parts di-pentaerythritol hexaacrylate, 2.5 parts of EAB, 2.5 parts of Irgacure 907 and 0.1 parts of hydroquinone were introduced and processed by use of a three roll mill according to the conventional method. The tack value of the ink was adjusted to be 7 to 8 at 25° C.

Likewise, according to the recipe shown in Table 7, comparative example UV light curable ink 20 was prepared.

(Electron Beam Curable Inks 21 and 22 for Comparative Examples)

18 parts of Carmine 6B, 35 parts of Varnish V11, 26.9 parts of ditrimethylol propane tetraacrylate, 20 parts di-pentaerythritol hexaacrylate, and 0,1 parts of hydroquinone were introduced and processed by use of a three roll mill according to the conventional method. The tack value of the ink was adjusted to be 7 to 8 at 25° C. Likewise, according to the recipe shown in Table 7, comparative example electron beam curable ink 22 was prepared.

Evaluation of Curable Inks

The present invention was evaluated by means of gloss-back tests. In the case of UV irradiation:

With Maricoat paper (Coat Board paper commercially available from Hokuetsu Paper Mills Ltd.) and a R1 tester (a compact test printer manufactured by Mei-Seisakusho Ltd.), transfer printing was performed with an ink coating volume of 0.3 cc. Immediately thereafter, by use of a wire-bar #3K-rocks proofer (manufactured by RK Print Coat Instrument Ltd.), a UV curable varnish (FDPCA902 Varnish commercially available from Toyo Ink Mfg. Co. Ltd.) was coated, and UV light was radiated thereon. Immediately thereafter and after 72 hrs, gloss was measured. In addition, adhesiveness tests by means of cellophane tape peeling were performed. UV light was irradiated by use of an irradiation equipment UVC-2535 (with one piece of 120 W/cm high voltage Mercury Ozone no-cut lamp and at a conveyer speed of 30 m/min) manufactured by Ushio Inc. A glossimeter manufactured by Murakami Shikisai Gijyutsu Kenkyusho was used under the condition of 60 degrees. In the case of electron beam irradiation:

Under the same conditions with those of the UV irradiation, transfer-printing process was carried out, an EB curable varnish (one that has been obtained by removing an initiator from FDPCA902) was coated, and immediately thereafter an electron beam was irradiated thereon. The electron beam was irradiated at 30 KGy by use of a low energy electron beam generator (an applied voltage of 175 kV and 500 ppm oxygen-containing nitrogen-substituted atmosphere) manufactured by Energy Science, Inc. The results are shown in Table 8.

TABLE 8

| | Printing | | Printing | | Type of | Glossiness | | |
|---|---|---|---|---|---|---|---|---|
| | System | | Material | | Energy | Immediate | After | |
| | Ink | Varnish | Ink | Varnish | Beam | after | 72 hrs. | Adhesiveness |
| Example 1 | HB ink | UV | Ink 1 | FDPCA | UV | 83 | 76 | O |
| | | varnish | | 902 | | | | |
| Example 2 | HB ink | UV | Ink 2 | FDPCA | UV | 84 | 75 | O |
| | | varnish | | 902 | | | | |
| Example 3 | HB ink | UV | Ink 3 | FDPCA | UV | 84 | 75 | O |
| | | varnish | | 902 | | | | |
| Example 4 | HB ink | UV | Ink 4 | FDPCA | UV | 85 | 77 | O |
| | | varnish | | 902 | | | | |
| Example 5 | HB ink | UV | Ink 5 | FDPCA | UV | 84 | 74 | O |
| | | varnish | | 902 | | | | |
| Example 6 | HB ink | UV | Ink 6 | FDPCA | UV | 85 | 76 | O |
| | | varnish | | 902 | | | | |
| Example 7 | HB ink | UV | Ink 7 | FDPCA | UV | 84 | 75 | O |
| | | varnish | | 902 | | | | |
| Example 8 | HB ink | UV | Ink 8 | FDPCA | UV | 84 | 75 | O |
| | | varnish | | 902 | | | | |
| Example 9 | HB ink | EB | Ink 9 | FDPCA | EB | 83 | 76 | O |
| | | varnish | | 902 | | | | |
| | | | | without | | | | |
| | | | | initiator | | | | |
| Example 10 | HB ink | EB | Ink 10 | FDPCA | EB | 84 | 77 | O |
| | | varnish | | 902 | | | | |
| | | | | without | | | | |
| | | | | initiator | | | | |
| Example 11 | HB ink | UV | Ink 11 | FDPCA | UV | 84 | 75 | O |
| | | varnish | | 902 | | | | |
| Example 12 | HB ink | UV | Ink 12 | FDPCA | UV | 83 | 76 | O |
| | | varnish | | 902 | | | | |
| Example 13 | HB ink | UV | Ink 13 | FDPCA | UV | 82 | 77 | O |
| | | varnish | | 902 | | | | |
| Example 14 | HB ink | EB | Ink 14 | FDPCA | EB | 82 | 75 | O |
| | | varnish | | 902 | | | | |
| | | | | without | | | | |
| | | | | initiator | | | | |
| Example 15 | HB ink | EB | Ink 15 | FDPCA | EB | 83 | 76 | O |
| | | varnish | | 902 | | | | |
| | | | | without | | | | |
| | | | | initiator | | | | |
| Comparative | oil- | UV | Ink 16 | FDPCA | UV | 85 | 59 | X |
| example 1 | based ink | varnish | | 902 | | | | |
| Comparative | oil- | UV | Ink 17 | FDPCA | UV | 84 | 58 | X |
| example 2 | based ink | varnish | | 902 | | | | |
| Comparative | oil- | UV | Ink 18 | FDPCA | UV | 84 | 60 | X |
| example 3 | based ink | varnish | | 902 | | | | |
| Comparative | UV ink | UV | Ink 19 | FDPCA | UV | 85 | 81 | O |
| example 4 | | varnish | | 902 | | | | |
| Comparative | UV ink | UV | Ink 20 | FDPCA | UV | 86 | 82 | O |
| example 5 | | varnish | | 902 | | | | |
| Comparative | oil- | EB | Ink 16 | FDPCA | EB | 85 | 60 | X |
| example 6 | based ink | varnish | | 902 | | | | |
| | | | | without | | | | |
| | | | | initiator | | | | |
| Comparative | oil- | EB | Ink 18 | FDPCA | EB | 84 | 59 | X |
| example 7 | based ink | varnish | | 902 | | | | |
| | | | | without | | | | |
| | | | | initiator | | | | |
| Comparative | EB ink | EB | Ink 21 | FDPCA | EB | 85 | 81 | O |
| example 8 | | varnish | | 902 | | | | |
| | | | | without | | | | |
| | | | | initiator | | | | |
| Comparative | EB ink | EB | Ink 22 | FDPCA | EB | 84 | 80 | O |
| example 9 | | varnish | | 902 | | | | |
| | | | | without | | | | |
| | | | | initiator | | | | |

Next, the present invention was evaluated based on blanket swell tests.

Each of ink components and raw materials was put on a blanket S7400 that is manufactured by Kinyo Co. Ltd. and generally used in oil-soluble ink tests. After 72 hrs have passed, a swell of the blanket was measured by use of a microgauge for each sample. The difference between thicknesses of the blanket before and after the swelling was divided by the thickness before the swelling occurred, followed by multiplying by 100, thereby a percentage (%) swell was obtained. In Table 9, 0-0.5% will be regarded as “good” in swelling, 0.6-0.9% as being in a practical level although slight swelling was observed, and 1.0% or more percentage is “bad”. In addition, after each of the inks was printed by use of the R1 tester, cleanability of the ink was evaluated by use of a mineral terpene.

TABLE 9

| | Ink | Ink type | Swell (%) | Cleanability |
|---|---|---|---|---|
| Example Ink | Ink 1 | HB ink | 0.8 | ◯ |
| | Ink 2 | HB ink | 0.7 | ◯ |
| | Ink 3 | HB ink | 0.8 | ◯ |
| | Ink 4 | HB ink | 0.9 | ◯ |
| | Ink 5 | HB ink | 0.8 | ◯ |
| | Ink 6 | HB ink | 0.9 | ◯ |
| | Ink 7 | HB ink | 0.8 | ◯ |
| | Ink 8 | HB ink | 0.7 | ◯ |
| | Ink 9 | HB ink | 0.6 | ◯ |
| | Ink 10 | HB ink | 0.6 | ◯ |
| | Ink 11 | HB ink | 0.6 | ◯ |
| | Ink 12 | HB ink | 0.5 | ◯ |
| | Ink 13 | HB ink | 0.5 | ◯ |
| | Ink 14 | HB ink | 0.5 | ◯ |
| | Ink 15 | HB ink | 0.5 | ◯ |
| Comparative | Ink 16 | Oil based ink | 0.2 | ◯ |
| Example Ink | Ink 18 | Oil based ink | 0.2 | ◯ |
| | Ink 19 | UV ink | 2.1 | X |
| | Ink 20 | UV ink | 2 | X |
| | Ink 21 | EB ink | 1.8 | X |
| | Ink 22 | EB ink | 1.8 | X |

Note:
“◯”, excellent, and “X”, bad in cleanability.

What is claimed is:

1. A curable coating composition, comprising:
a polymer of an aromatic vinyl compound and an α,β-unsaturated carboxylic acid ester;
a vegetable oil or a fatty acid ester thereof; and
a (metha) acrylic monomer or (metha) acrylic oligomer.

2. The curable coating composition according to claim 1, wherein the α,β-unsaturated carboxylic acid ester is a (metha) acrylic acid ester of a C1 to C20 monohydric fatty alcohol.

3. The curable coating composition according to claim 1, wherein the α,β-unsaturated carboxylic acid ester is a (metha) acrylic acid ester of a C5 to C60 cyclic alcohol.

4. The curable coating composition as set forth in claim 3, wherein the C5 to C60 cyclic alcohol is terpene alcohol.

5. The curable coating composition according to claim 1, further comprising a resin having a softening temperature in the range of 50 to 180° C.

6. The curable coating composition according to claim 1, further comprising a metallic dryer and/or a radical polymerization initiator.

7. The curable coating composition according to claim 1, further comprising a coloring agent.

8. A printing ink comprising the curable coating composition according to claim 7.

9. A method for printing a curable ink on a substrate, said method comprising the steps of:
(a) applying the printing ink of claim 8 on a substrate to form an ink surface of the printing ink;
(b) further applying, in an uncured state of the printing ink, an activation energy beam curable overcoat varnish on the ink surface; and,
(c) irradiating an activation energy beam onto the printing ink and activation energy beam curable overcoat varnish applied.

10. A printed matter produced according to the method of claim 9.

11. The curable coating composition according to claim 1, wherein the aromatic vinyl compound is in an amount of 1 to 99% by weight based on a total amount of the aromatic vinyl compound and the α,β-unsaturated carboxylic acid ester.

12. The curable coating composition according to claim 1, wherein the polymer is in an amount of 1 to 50% by weight based on an amount of the curable coating composition.
